(19) United States
(12) Patent Application Publication
(10) Pub. No.: US 2014/0198997 A1
(43) Pub. Date: Jul. 17, 2014

(54) INFORMATION PROCESSING APPARATUS, METHOD, AND PROGRAM

(71) Applicant: SONY CORPORATION, Tokyo (JP)

(72) Inventor: Takahiro FUKUHARA, Kanagawa (JP)

(73) Assignee: SONY CORPORATION, Tokyo (JP)

(21) Appl. No.: 14/151,542

(22) Filed: Jan. 9, 2014

(30) Foreign Application Priority Data
Jan. 16, 2013 (JP) 2013-005341

(51) Int. Cl. G06F 17/30

(52) U.S. Cl. CPC G06F 17/30244
USPC 382/305

(57) ABSTRACT

An information processing apparatus includes a first storage unit which stores coded data obtained by coding image data; a second storage unit, storage capacity of which is smaller compared to that of the first storage unit, data reading and writing speeds of which are higher compared to those of the first storage unit; and a control unit which receives the coded data, and stores the coded data on the first storage unit when a data length of the received coded data is longer compared to a predetermined threshold value, or stores the coded data on the second storage unit, reads the coded data in units of data length which is longer compared to the threshold value from the second storage unit, stores the coded data on the first storage unit when the data length of the received coded data is shorter compared to the predetermined threshold value.

### CROSS REFERENCE TO RELATED APPLICATIONS

This application claims the benefit of Japanese Priority Patent Application JP 2013-005341 filed Jan. 16, 2013, the entire contents of which are incorporated herein by reference.

### BACKGROUND

The present disclosure relates to information processing apparatus, method, and program, and particularly to information processing apparatus, method, and program which make it possible to efficiently record and reproduce data.

In the related art, there is a system which transmits image data to a server and causes the server to record the image data, such as a medical image compression and transmission system (see Japanese Unexamined Patent Application Publication No. 7-141498, for example).

For the system disclosed in Japanese Unexamined Patent Application Publication No. 7-141498, an image compression apparatus 2 saves the image data to be transmitted to a file server both in a RAM and a non-volatile memory in order not to lose, due to trouble or defect of equipment, a pathological image of a patient which is captured by an endoscope. Furthermore, the image compression apparatus 2 transmits the image data to the file server and causes the file server to record the image data.

In recent years, not only a hard disk but also a solid state drive (SSD) with a built-in flash memory have been employed as a recording medium of such a server in order to achieve high throughput and low power consumption.

However, the number of times of rewriting data in the SSD, which is relatively large data unit, is limited, and data can be written only one page at a time. In order to write new data in a region, in which data was already written once in the SSD, it is necessary to delete the old data. Furthermore, the deletion can be performed only in larger units of data and not in units of pages. For this reason, there is a region where no data is written when data is small-sized, and there is a problem that the storage region is inefficiently used. In addition, since the number of accesses increases when numerous small data items are written, there is not only a concern about writing speed decreasing but also a concern about power consumption increasing.

Thus, a method was contrived in which a cache memory was separately provided, and supplied data to be written was once stored in the cache memory, collected at least in larger units of data than in units of pages, and then written.

### SUMMARY

However, there is a growing demand for uploading a large amount of data called big data to a cloud. For such big data, the data size is larger in each page unit, and therefore the region, in which writing is inhibited despite no data being written, hardly exists and a decrease in efficiency of using the storage region is suppressed even when the big data is recorded without being stored in the cache memory once before.

That is, there is a concern that the writing speed is unnecessarily reduced in accordance with the operation of maintaining the big data once in the cache memory when such big data is recorded via the cache memory. In addition, it is necessary to secure sufficient capacity for maintaining the big data for expensive cache memory, and there is a concern that the manufacturing cost increases. That is, there is a concern that the data is not sufficiently and efficiently written.

The same is true for reproducing the data, and there is not only a concern that a reading speed is reduced due to an increase in the number of accesses but also a concern that power consumption increases when small data is repeatedly read. A method was contrived in which a cache memory was separately provided, and data read from the storage region was once stored in the cache memory, collected in predetermined large units of data, and then output.

However, there is a concern that the reading speed is unnecessarily reduced in accordance with the operation of maintaining the big data once in the cache memory when the big data is read via the cache memory even during reproduction. In addition, it is necessary to secure sufficient capacity for maintaining the big data for the expensive cache memory, and there is a concern that the manufacturing cost increases. That is, there is a concern that data is not sufficiently and efficiently read.

It is desirable to suppress an increase in power consumption, a decrease in a data reading speed and a data writing speed, and a decrease in a period, during which data can be written in a recording medium, by enhancing efficiency of recording and reproducing data.

According to an embodiment of the present disclosure, there is provided an information processing apparatus including: a first storage unit which stores coded data obtained by coding image data; a second storage unit, which stores the coded data, storage capacity of which is smaller than that of the first storage unit, and a data reading speed and a data writing speed of which are higher than those of the first storage unit; and a control unit which receives the coded data, and supplies the coded data to the first storage unit and causes the first storage unit to store the coded data when a data length of the received coded data is longer than a predetermined threshold value, or supplies the coded data to the second storage unit, causes the second storage unit to store the coded data, reads the coded data in units of data length which is longer than the threshold value from the second storage unit, supplies the coded data to the first storage unit, and causes the first storage unit to store the coded data when the data length of the received coded data is shorter than the predetermined threshold value.

In the embodiment, the control unit may supply the coded data to the first storage unit and cause the first storage unit to store the coded data when a format of the received coded data is a known moving image data format.

In the embodiment, the control unit may supply the coded data to the first storage unit and cause the first storage unit to store the coded data when the received coded data is obtained by coding the image data in units of pictures.

In the embodiment, the control unit may supply the coded data to the second storage unit and cause the second storage unit to store the coded data when the received coded data is obtained by coding the image data in units of tiles.

In the embodiment, the control unit may supply the coded data to the second storage unit and cause the second storage unit to store the coded data when the received coded data is obtained by coding the image data in units of tiles and the data length is shorter than a threshold value for the tiles.

In the embodiment, the control unit may supply the coded data to the second storage unit and cause the second storage unit to store the coded data when the received coded data is obtained by coding the image data in units of macro-blocks.

In the embodiment, the control unit may supply the coded data to the second storage unit and cause the second storage unit to store the coded data when the received coded data is obtained by coding the image data in units of macro-blocks and the data length is shorter than a threshold value for the macro-blocks.

In the embodiment, the control unit may supply the coded data to the second storage unit and cause the second storage unit to store the coded data when the received coded data is obtained by coding the image data in units of line blocks.

In the embodiment, the control unit may supply the coded data to the second storage unit and cause the second storage unit to store the coded data when the received coded data is obtained by coding the image data in units of line blocks and the data length is shorter than a threshold value for the line blocks.

In the embodiment, the coded data may be obtained by performing wavelet transform on the image data and coding the obtained wavelet transform coefficients, and each of the line blocks may be a block of the image data including a necessary number of lines for generating at least one line of lowest components in the wavelet transform.

In the embodiment, the first storage unit may include a non-volatile memory.

In the embodiment, the non-volatile memory may be a NAND flash memory.

In the embodiment, the second storage unit may include a non-volatile memory.

In the embodiment, the non-volatile memory may be a magnetic memory.

In the embodiment, the magnetic memory may be an MRAM.

In the embodiment, the non-volatile memory may be a resistance variation-type memory.

In the embodiment, the resistance variation-type memory may be an ReRAM.

In the embodiment, when the coded data stored on the first storage unit is read and output, the control unit may output the coded data read from the first storage unit when a line speed is high, or supply the coded data read from the first storage unit to the second storage unit, cause the second storage unit to store the coded data, and read and output the coded data from the second storage unit at a predetermined timing when the line speed is low.

According to another embodiment of the present disclosure, there is provided an information processing method including: receiving coded data obtained by coding image data; and supplying the coded data to a first storage unit and causing the first storage unit to store the coded data when a data length of the received coded data is longer than a predetermined threshold value; or supplying the coded data to a second storage unit, causing the second storage unit to store the coded data, reading the coded data in units of data length which is longer than the threshold value from the second storage unit, supplying the coded data to the first storage unit, and causing the first storage unit to store the coded data when the data length of the received coded data is shorter than the predetermined threshold value, storage capacity of the second storage unit being smaller than that of the first storage unit, a data reading speed and a data writing speed of the second storage unit being higher than those of the first storage unit.

According to still another embodiment of the present disclosure, there is provided a program which causes a computer to execute processing of: receiving coded data obtained by coding image data; and supplying the coded data to a first storage unit and causing the first storage unit to store the coded data when a data length of the received coded data is longer than a predetermined threshold value; or supplying the coded data to a second storage unit, causing the second storage unit to store the coded data, reading the coded data in units of data length which is longer than the threshold value from the second storage unit, supplying the coded data to the first storage unit, and causing the first storage unit to store the coded data when the data length of the received coded data is shorter than the predetermined threshold value, storage capacity of the second storage unit being smaller than that of the first storage unit, a data reading speed and a data writing speed of the second storage unit being higher than those of the first storage unit.

In the embodiments, the coded data obtained by coding the image data is received, and the coded data is supplied to and stored on the first storage unit when the data length of the received coded data is longer than a predetermined threshold value, or the coded data is supplied to and stored on the second storage unit, read in units of data length which is longer than the threshold value from the second storage unit, and supplied to and stored on the first storage unit when the data length of the received coded data is shorter than the predetermined threshold value, storage capacity of the second storage unit being smaller than that of the first storage unit, a data reading speed and a data writing speed of the second storage unit being higher than those of the first storage unit.

According to the present disclosure, information can be processed. Particularly, it is possible to more efficiently write data in a recording medium and read data from the recording medium.

### BRIEF DESCRIPTION OF THE DRAWINGS

FIG. 1 is a diagram showing a main configuration example of an information processing system;

FIG. 2 is a block diagram showing a main configuration example of a memory storage;

FIG. 3 is a block diagram showing a main configuration of a controller;

FIG. 4 is a diagram illustrating a configuration example of a moving image file;

FIG. 5 is a diagram illustrating an example when coding is performed in units of pictures;

FIG. 6 is a diagram illustrating an example when coding is performed in units of slices;

FIG. 7 is a diagram illustrating an example when coding is performed in units of macro-blocks;

FIG. 8 is a block diagram showing a configuration example of a slice and a macro-block;

FIG. 9 is a diagram illustrating an example when coding is performed in units of tiles;

FIG. 10 is a block diagram showing a configuration example of a tile;

FIG. 11 is a flowchart illustrating an example of a flow of recording processing;

FIG. 12 is a block diagram showing another configuration example of the memory storage;

FIG. 13 is a flowchart illustrating another example of the flow of the recording processing;

FIG. 14 is a diagram illustrating an example when coding is performed in units of line blocks;

FIG. 15 is a block diagram showing a configuration of an example of an image coding apparatus;

FIG. 16 is an outline diagram schematically illustrating wavelet transform;

FIGS. 17A and 17B are outline diagrams schematically illustrating the wavelet transform;

FIG. 18 is an outline diagram schematically illustrating the wavelet transform when a lifting technology is applied to a 5×3 filter;

FIG. 19 is an outline diagram schematically illustrating the wavelet transform when the lifting technology is applied to the 5×3 filter;

FIG. 20 is an outline diagram showing an example in which filtering based on the lifting of the 5×3 filter is executed up to a decomposition level=2;

FIGS. 21A to 21C are outline diagrams schematically showing flows of the wavelet transform and wavelet inverse transform;

FIG. 22 is a flowchart illustrating an example of a flow of coding processing;

FIG. 23 is a block diagram showing a configuration of an example of an image decoding apparatus;

FIG. 24 is a flowchart illustrating an example of a flow of decoding processing;

FIGS. 25A to 25H are outline diagrams schematically showing an example of parallel operations;

FIG. 26 is a pattern diagram illustrating an example of a state where coded data is exchanged;

FIG. 27 is a flowchart illustrating still another example of the flow of the recording processing;

FIG. 28 is a diagram illustrating an example of a state where data in the memory storage is read;

FIG. 29 is a diagram illustrating an example of a state where data is read for a high line speed;

FIG. 30 is a diagram illustrating an example of a state where data is read for a low line speed;

FIG. 31 is a flowchart illustrating an example of a flow of reading processing; and

FIG. 32 is a block diagram showing a main configuration example of a computer.

### DETAILED DESCRIPTION OF EMBODIMENTS

Hereinafter, a description will be given of embodiments for implementing the present disclosure (herein after, simply referred to as embodiments). In addition, the description will be given in the following order.

### 1. First Embodiment (Data Writing in Memory Storage)

### 2. Second Embodiment (Data Writing in Memory Storage in Units of Line Blocks)

3. Third Embodiment (Data Reading from Memory Storage)

### 4. Fourth Embodiment (Computer)

### 1. First Embodiment

### Information Processing System

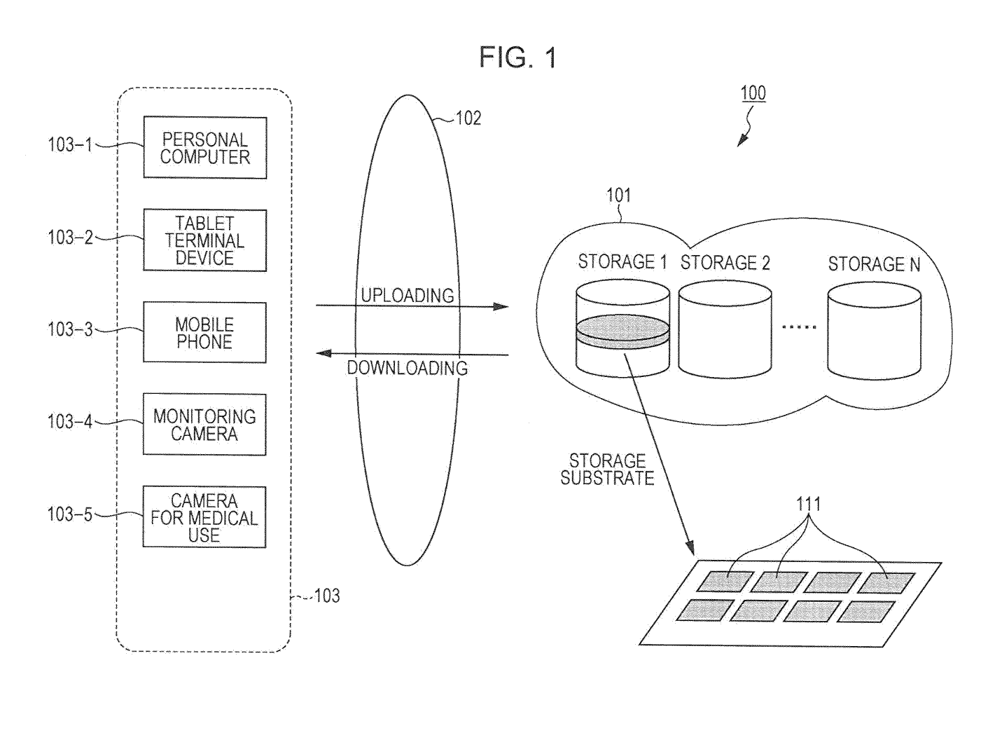

FIG. 1 is a diagram showing a main configuration example of an information processing system which transmits and receives data. An information processing system 100 shown in FIG. 1 is a system, in which a cloud server 101 and a client 103 exchange data via a network 102.

The cloud server 101 is an information processing apparatus which communicates with the client 103 via the network 102 and provides services of obtaining and storing data from the client 103 and supplying recorded data to the client 103.

Any cloud server 101 is applicable as long as the cloud server has a communication function of exchanging data with the client 103 via the network 102 and a storage function of storing data supplied from the client 103 and data to be supplied to the client 103, and the other configurations can be arbitrarily selected.

The cloud server 101 typically stores an enormous amount of data in order to provide services to multiple clients 103. For this reason, the cloud server 101 includes a plurality of large-capacity storages (a storage 1 to storage N (N is an arbitrary natural number) in the case of the example shown in FIG. 1) as the storage function.

Although each storage may be configured of an inexpensive hard disk drive (HDD) with high reading and writing speeds, for example, it is necessary to provide large drive current to read and write data from and in the disk, and there is a concern that it is necessary to provide larger power for a large-scaled storage.

In the example shown in FIG. 1, the storage is implemented by using a solid state drive (SSD). The SSD is a semiconductor memory with a built-in flash memory and has an excellent reading performance at the time of random access even when a unit price per capacity is higher than that of the hard disk. In addition, since the flash memory which is a non-volatile memory is used, the SSD can maintain content of data over a long period even after disconnection of the power. Moreover, the SSD consumes less power than the hard disk and has excellent durability.

In the example shown in FIG. 1, multiple storage substrates are mounted on each storage. Multiple memory storages 111 are arranged on each storage substrate. Each of the memory storages 111 is configured of the SSD.

The cloud server 101 manages all the storages, all the storage substrates on each storage, all the memory storages 111 on each storage substrate, and a storage region (address) of each memory storage 111.

The cloud server 101 selects one or more storages among a part or an entirety of the storages, selects one or more storage substrates among a part or an entirety of the storage substrates mounted on the one or more selected storages, selects one or more memory storages 111 among a part or an entirety of the memory storages 111 arranged on the one or more selected storage substrates, and writes data which is supplied from the client 103 in a predetermined address of the one or more selected memory storages 111, for example.

In addition, the cloud server 101 selects one or more storages among a part or an entirety of the storages, selects one or more storage substrates among a part or an entirety of the storage substrates mounted on the one or more selected storages, selects one or more memory storages 111 among a part or an entirety of the memory storages 111 arranged on the one or more selected storage substrates, reads data which is stored in a desired address of the one or more selected memory storages 111, and supplies the read data to the client 103 via the network 102, for example.

The cloud server 101 records data in an arbitrary memory storage 111 on an arbitrary storage substrate on an arbitrary storage at an arbitrary timing.

In addition, the respective storages may be configured of mutually different case bodies or may be installed at mutually distant locations. That is, the cloud server 101 may be configured of a plurality of devices as long as the plurality of apparatuses have functions of the cloud server 101 as a whole.

The network 102 is an arbitrary communication medium between the cloud server 101 and the client 103. The network 102 is configured of one or more networks. In addition, the network 102 may be a wired network or a wireless network or may include both the wired network and the wireless network. More specifically, the network 102 includes the Internet, for example. The network 102 includes local area networks (LANs) in hospitals, companies, and homes, for example.

The client 103 is configured of an arbitrary information processing apparatus capable of communicating with the cloud server 101. For example, the client 103 is configured of a personal computer 103-1, a tablet terminal device 103-2, a mobile phone 103-3, a monitoring camera 103-4, or a camera for a medical use 103-5. The client 103 may be an information processing apparatus other than the examples shown in FIG. 1. In addition, the number of the clients 103 is arbitrary.

Next, a description will be given of a specific operation example of the information processing system 100.

The client 103 images an object and generates image data, for example. The image data may be a moving image or a stationary image. The client 103 codes (compresses) the image data in order to reduce a band width of the network 102 necessary for transmitting the data. An arbitrary coding scheme can be employed. For example, Moving Picture Experts Group (MPEG)-2, MPEG-4, Advanced Video Coding (AVC), Joint Photographic Experts Group (JPEG), or JPEG 2000 may be employed. The client 103 supplies (uploads) the coded data, which is generated by coding the image data as described above, to the cloud server 101 via the network 102.

The cloud server 101 causes the coded data, which is supplied from the client 103, to be stored on any of the memory storages 111.

In addition, the cloud server 101 reads the coded data, which is stored on the memory storage 111 (the coded data obtained by coding image data by the client 103, for example), in response to a request or the like from the client 103 and supplies (downloads) the coded data to the client 103 via the network 102.

The aforementioned data transmission is performed in the information processing system 100.

### SSD

Incidentally, the number of times of rewriting data in the SSD is limited, and data can be written only in each page, which is relatively large data unit. In addition, it is necessary to delete old data in order to write new data in a region, in which the data was written once, in the SSD. Furthermore, the deletion can be performed only in larger units of data and not in units of pages. For this reason, there is a concern that a region where no data can be written occurs and the storage region is inefficiently used when small-sized data is written. In addition, since the number of accesses increases when many small data items are written, there is not only a concern that a writing speed decreases but also a concern that power consumption increases.

Thus, a method was contrived in which a cache memory was separately provided, and supplied data to be written was once stored in the cache memory, collected at least in larger units of data than in units of pages, and then written.

However, for big-sized data such as coded data obtained by coding image data (hereinafter, also referred to as big data), the data size is larger than that in each page unit, and therefore the region, in which writing is inhibited regardless of that no data has been written, does not easily occur and a decrease in efficiency of using the storage region is suppressed even when the big data is recorded without being stored in the cache memory once.

That is, there is a concern that the writing speed is unnecessarily reduced in accordance with the operation of maintaining the big data once in the cache memory when such big data is recorded via the cache memory. In addition, it is necessary to secure sufficient capacity for maintaining the big data for the expensive cache memory, and there is a concern that the manufacturing cost increases. That is, there is a concern that data is not sufficiently and efficiently written.

The same is true for reproducing the data, and there is not only a concern that a reading speed is reduced due to an increase in the number of accesses but also a concern that power consumption increases when small data is repeatedly read. A method was contrived in which a cache memory was separately provided, and the data read from the storage region was once stored in the cache memory, collected in predetermined large units of data, and then output.

However, there is a concern that the reading speed is unnecessarily reduced in accordance with the operation of maintaining the big data once in the cache memory when the big data is read via the cache memory even during reproduction. In addition, it is necessary to secure sufficient capacity for maintaining the big data for the expensive cache memory, and there is a concern that the manufacturing cost increases. That is, there is a concern that data is not sufficiently and efficiently read.

### Memory Storage

Thus, the memory storage 111 stores coded data on a flash memory for saving data without storing the coded data on the cache memory when the size of the coded data is large (in other words, when a data length is long), and the memory storage 111 supplies the coded data to the cache memory, stores the coded data once on the cache memory, reads and supplies the coded data of a larger data size compared to a predetermined data size (in other words, the coded data of a longer data length compared to a predetermined data length) from the cache memory to the flash memory for saving data, and causes the flash memory for saving data to store the coded data when the size of the coded data is small (in other words, when the data length is short).

In doing so, the memory storage 111 can more efficiently record and reproduce the data. Therefore, the memory storage 111 can suppress an increase in power consumption, a decrease in a data reading speed and a data writing speed, and a decrease in a period, during which data can be written in a recording medium.

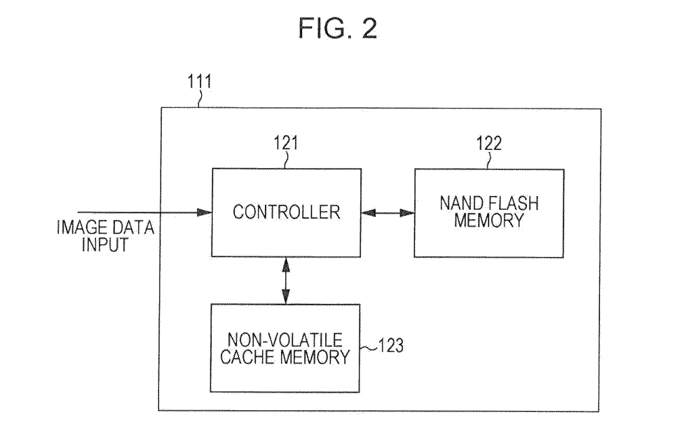

FIG. 2 is a block diagram showing a main configuration example of the memory storage 111.

As shown in FIG. 2, the memory storage 111 includes a controller 121, a NAND flash memory 122, and a non-volatile cache memory 123.

The controller 121 obtains coded data (image data) which is uploaded by the client 103, then supplies the coded data to the NAND flash memory 222 or the non-volatile cache memory 123, and causes the NAND flash memory 122 or the non-volatile cache memory 123 to store the coded data. The controller 121 controls which one of the NAND flash memory 122 and the non-volatile cache memory 123 the coded data is to be supplied in accordance with the size of the coded data.

In addition, the controller 121 reads the coded data, which is stored on the non-volatile cache memory 123, of a larger data size compared to the predetermined data size, supplies the coded data to the NAND flash memory 122, and causes the NAND flash memory 122 to store the coded data.

The NAND flash memory 122 (also referred to as a NAND-type flash memory) is a rewritable non-volatile semiconductor memory and can implement a large-capacity storage region at a relatively low cost. The flash memory has an excellent reading performance at the time of random access and can maintain content of data over a long period even after disconnection of the power since the flash memory is a non-volatile memory. For this reason, the flash memory consumes less power compared to a hard disk. In addition, since the flash memory is not physically driven, the flash memory has more excellent durability compared to the hard disk.

The non-volatile cache memory 123 is a rewritable non-volatile semiconductor memory and can read and write data at a higher speed compared to the NAND flash memory 122. The NAND flash memory 122 and the non-volatile cache memory 123 have arbitrary capacity. However, the non-volatile cache memory 123 is more expensive compared to the NAND flash memory 122. For this reason, the non-volatile cache memory 123 is typically formed to have smaller capacity compared to that of the NAND flash memory 122. The non-volatile cache memory 123 may be a magnetic memory (also referred to as a magnetoresistive memory) (such as a Magnetic Random Access Memory (MRAM)) or a resistance variation-type memory (such as a Resistance Random Access Memory (ReRAM)), for example.

The NAND flash memory 122 is a memory for saving data, and the non-volatile cache memory 123 is a cache memory which temporarily stores small-sized coded data to be saved in the NAND flash memory 122 before the NAND flash memory 122 saves the coded data.

The NAND flash memory 122 and the non-volatile cache memory 123 are controlled by the controller 121 to read and write coded data.

As described above, the memory storage 111 can reduce the number of accesses to the NAND flash memory 122 and further increase the speed of the coded data writing processing by utilizing the non-volatile cache memory 123. In addition, the memory storage 111 can further extend the period, during which data can be written in the NAND flash memory 122 (that is, a lifetime of the NAND flash memory 122) by reducing the number of accesses to the NAND flash memory 122.

In addition, since the non-volatile cache memory 123 used as the cache memory is a non-volatile memory, it is not necessary to evacuate the data stored on the cache memory when the power is turned on or off. For this reason, it is possible to turn on or off the power at a higher speed compared with a case where a volatile memory is used as the cache memory. In other words, data on the cache memory is not lost even when the power is unintentionally turned off.

That is, the non-volatile cache memory 123 can cache the data more safely.

### Controller

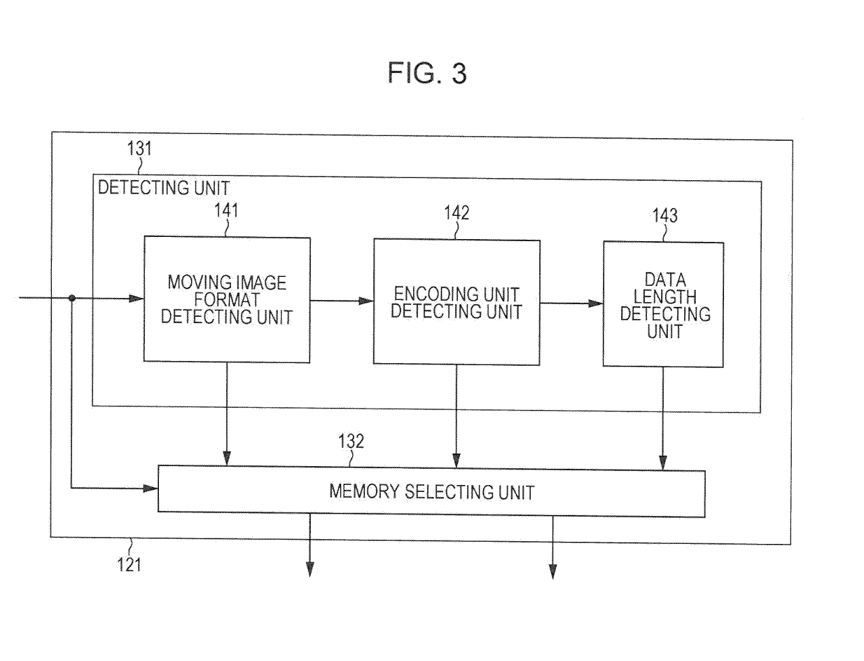

FIG. 3 is a block diagram showing a main configuration example of the controller 121 shown in FIG. 2.

As shown in FIG. 3, the controller 121 includes a detecting unit 131 and a memory selecting unit 132.

The detecting unit 131 analyzes the supplied coded data and detects information relating to the data length of the coded data. The detecting unit 131 supplies the obtained detection result to the memory selecting unit 132.

The memory selecting unit 132 selects one of the NAND flash memory 122 and the non-volatile cache memory 123 as a supply destination of the input coded data (image data) based on the detection result supplied from the detecting unit 131. The memory selecting unit 132 supplies the input coded data to the selected memory (one of the NAND flash memory 122 and the non-volatile cache memory 123).

As shown in FIG. 3, the detecting unit 131 includes a moving image format detecting unit 141, an encoding unit detecting unit 142, and a data length detecting unit 143.

The moving image format detecting unit 141 determines whether or not image data of the input coded data configures one file in a known moving image format.

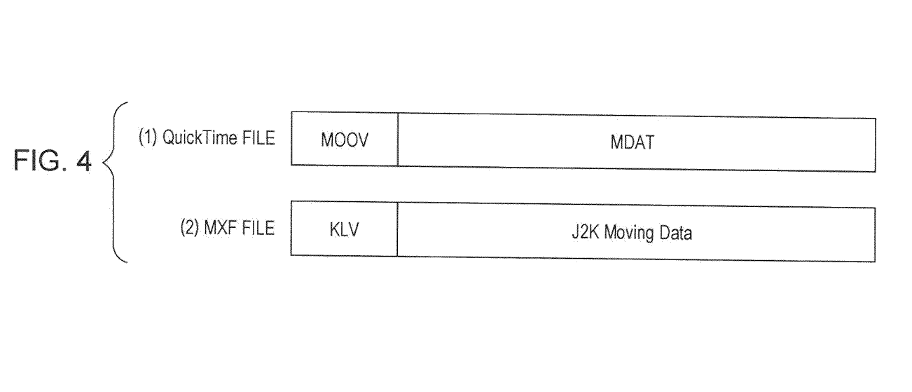

Information relating to existing moving image formats is registered in advance in the moving image format detecting unit 141. For example, a file in the QuickTime (trademark) format has a configuration shown in the upper part of FIG. 4. In addition, a file in the Material exchange Format (MXF) of the Society of Motion Picture and Television Engineers (SMPTE) has a configuration shown in the lower part of FIG. 4, for example. The moving image format detecting unit 141 detects the coded data, which is configured as one file with such configuration and is obtained by coding image data, based on the information registered in advance.

For detecting such coded data, the moving image format detecting unit 141 notifies the memory selecting unit 132 of the fact that the coded data has been detected.

For not detecting such coded data, the moving image format detecting unit 141 notifies the encoding unit detecting unit 142 of the fact that the coded data has not been detected and supplies the input coded data to the encoding unit detecting unit 142.

The encoding unit detecting unit 142 determines whether or not image data of the input coded data has been coded in the known units of data.

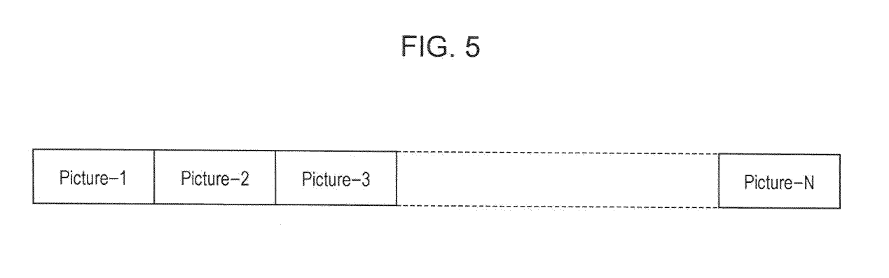

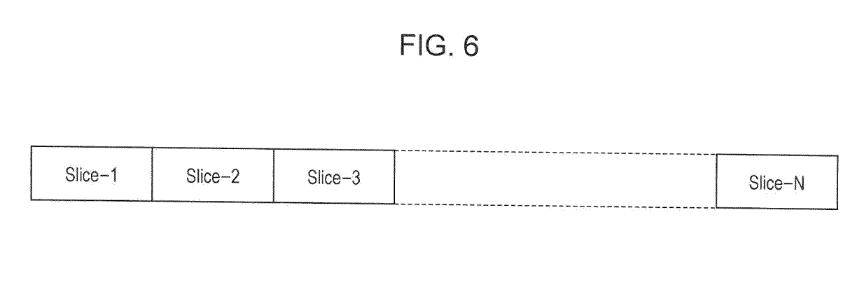

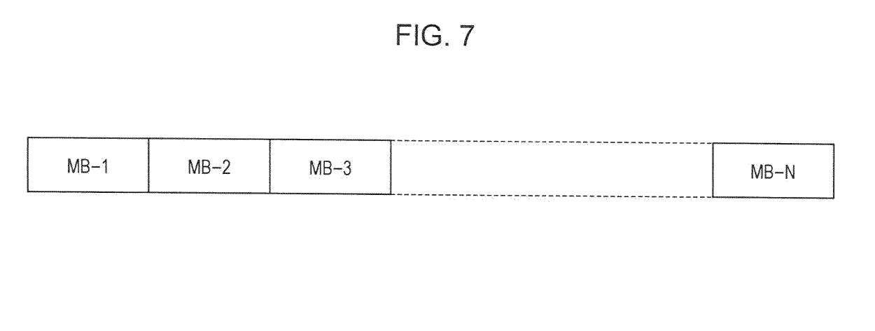

When the coded data is data coded by an MPEG-system encoder, for example, it can be considered that the coded data has been coded in units of pictures as shown in FIG. 5, in units of slices as shown in FIG. 6, or in units of macro-blocks (MBs) as shown in FIG. 7.

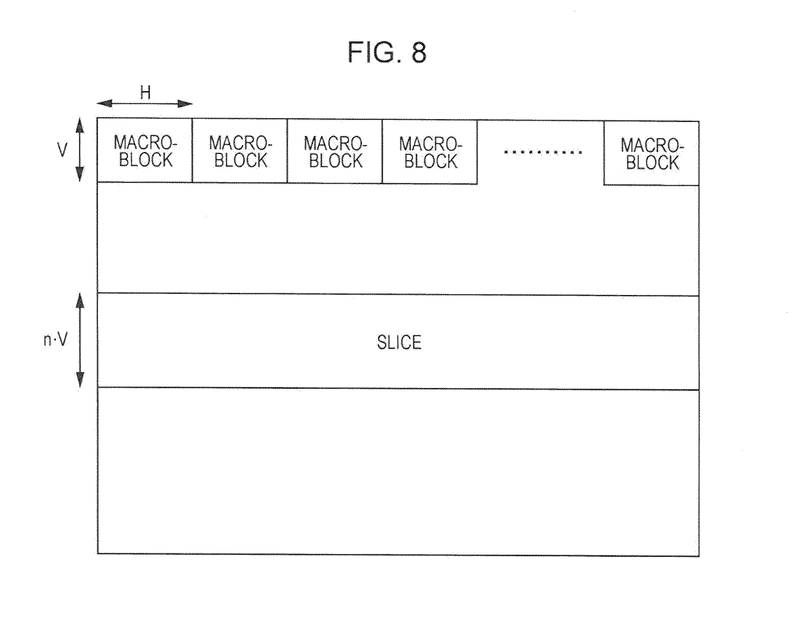

As shown in FIG. 8, a rectangular block with a horizontal size H and a vertical line number V in one picture is referred to as a macro-block (MB) and has a size of 16×16, a size of 8×8, or the like in the case of MPEG, for example. In addition, the slice is a band obtained when the macro-blocks are spread so as to cover the full horizontal size. There is a case of encoding data in units of slices for a low-delay use purpose of the MPEG system. Since the slice is a group of macro-blocks as shown in FIG. 8 and the same as a case where a plurality of macro-blocks are considered as a unit of data is true to the slice, a description relating to the coding in units of slices will be omitted below.

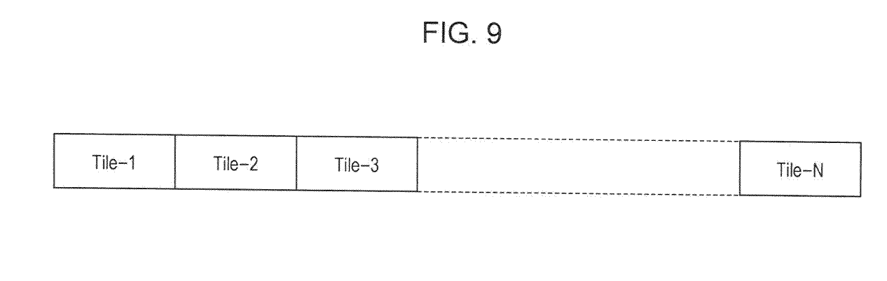

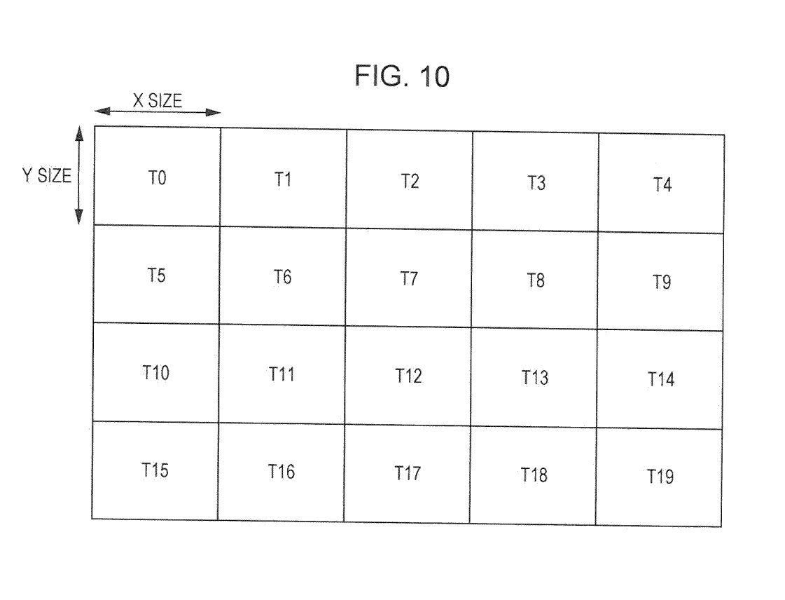

For Motion JPEG which is moving image version JPEG or Motion JPEG 2000 which is moving image version JPEG 2000, it can be considered that the data is coded in units of pictures as shown in FIG. 5 or in units of tiles as shown in FIG. 9. Each tile is a rectangular region obtained by dividing one picture to parts, each of which has a horizontal size of X size and a vertical line of Y size as in the example shown in FIG. 10. In the case of the example shown in FIG. 10, one picture is divided into twenty tiles T0 to T19. Tile encoding is performed in many cases for the purpose of saving memory when resolution of an input image is extremely high.

The encoding unit detecting unit 142 detects the coded data, which has been coded in such coding units, based on the information registered in advance.

For detecting such coded data, the encoding unit detecting unit 142 notifies the memory selecting unit 132 of the fact that the coded data has been detected.

For not detecting such coded data, the encoding unit detecting unit 142 notifies the data length detecting unit 143 of the fact that the coded data has not been detected and supplies the input coded data to the data length detecting unit 143.

The data length detecting unit 143 compares the data length of the image data of the coded data with a predetermined threshold value set in advance and determines whether or not the data length of the image data is longer compared to the threshold value. The data length detecting unit 143 notifies the memory selecting unit 132 of the detection result.

The memory selecting unit 132 selects one of the NAND flash memory 122 and the non-volatile cache memory 123 as the supply destination of the coded data in accordance with the detection result supplied from one of the moving image format detecting unit 141, the encoding unit detecting unit 142, and the data length detecting unit 143. The memory selecting unit 132 supplies the input coded data to the selected supply destination.

### Flow of Recording Processing

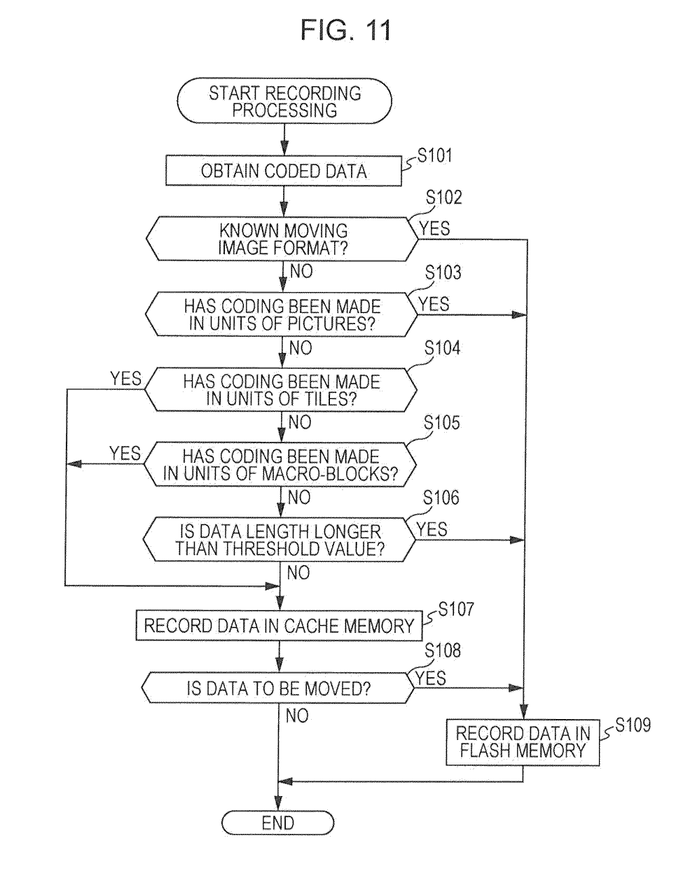

A description will be given of an example of a flow of recording processing which is executed by the controller 121 shown in FIG. 3 when the coded data supplied from the client 103 is recorded, with reference to the flowchart shown in FIG. 11.

When the recording processing is started, the moving image format detecting unit 141 of the detecting unit 131 obtains coded data in Step S01.

First, the detecting unit 131 examines whether or not the coded data configures a file in a known moving image format.

In Step S102, the moving image format detecting unit 141 determines whether or not the coded data has been obtained by coding image data configured as a file in a known moving image format, based on information (a parameter set or header information, for example) included in the obtained coded data. When it is determined that the coded data is not data obtained by coding image data configured as a file in a known moving image format, the processing proceeds to Step S103.

Since the coded data is not data obtained by coding the file in a known moving image format, the detecting unit 131 then examines a coding unit of the coded data.

In Step S103, the encoding unit detecting unit 142 determines whether or not the coded data has been created in units of pictures, based on the information (the parameter set or the header information, for example) included in the coded data. When it is determined that the coded data has not been created by encoding image data in units of pictures, the processing proceeds to Step S104.

In Step S104, the encoding unit detecting unit 142 determines whether or not the coded data has been created in units of tiles, based on the information (the parameter set or the header information, for example) included in the coded data. When it is determined that the coded data has not been created by encoding image data in units of tiles, the processing proceeds to Step S105.

In Step S105, the encoding unit detecting unit 142 determines whether or not the coded data has been created in units of macro-blocks, based on the information (the parameter set or the header information, for example) included in the coded data. When it is determined that the coded data has not been created by coding image data in units of macro-blocks, the processing proceeds to Step S106.

Since the coded data has not been created by coding image data in known coding units, the detecting unit 131 then examines the data length of the coded data.

In Step S106, the data length detecting unit 143 determines whether or not the data length of the coded data is longer compared to a predetermined threshold value, based on the information (the parameter set or the header information, for example) included in the coded data. The threshold value is set in advance, for example. The threshold value may be set (or updated) in response to an external instruction from a user, for example. When it is determined that the data length of the coded data is not longer compared to the threshold value, the processing proceeds to Step S107. In such a case, the data length of the coded data is determined to be sufficiently short.

Alternatively, the data length detecting unit 143 may determine whether or not the data length of the coded data is shorter compared to a predetermined threshold value in Step S106. The processing may proceed to Step S107 if it is determined that the data length of the coded data is shorter compared to the threshold value.

When it is determined in Step S104 that the coded data has been created by coding the image data in units of tiles, the processing also proceeds to Step S107. Since the image data has been coded in units of tiles in this case, the data length of the coded data is determined to be sufficiently short.

Furthermore, when it is determined in Step S105 that the coded data has been created by coding the image data in units of macro-blocks, the processing also proceeds to Step S107. Since the image data has been coded in units of macro-blocks in this case, the data length of the coded data is determined to be sufficiently short.

Accordingly, the memory selecting unit 132 selects the non-volatile cache memory 123 as a supply destination of the coded data in Step S107. That is, the memory selecting unit 132 supplies the coded data as a target of processing to the non-volatile cache memory 123 and causes the non-volatile cache memory 123 to store the coded data (that is, the memory selecting unit 132 records the coded data in the non-volatile cache memory 123).

In Step S108, the memory selecting unit 132 determines whether or not to move the coded data which is recorded in the non-volatile cache memory 123 (the coded data stored on the non-volatile cache memory 123) to the NAND flash memory 122. Whether or not to move the data is determined under an arbitrary condition. For example, the data may be moved under a condition that the amount of coded data stored on the non-volatile cache memory 123 has reached a predetermined amount (for example, a data amount which is equal to or greater compared to that in a unit of page as a writing unit of the NAND flash memory 122).

When the condition is not satisfied and it is determined that the data is not to be moved, the recording processing is completed.

If it is determined in Step S102 that the coded data has been created by coding the image data configured as a file in a known moving image format, the processing proceeds to Step S109. Since the coded data has been created by coding a moving image file in this case, the data length of the coded data is determined to be sufficiently long.

If it is determined in Step S103 that the coded data has been created by coding the image data in units of pictures, the processing proceeds to Step S109. Since the coded data has been created by coding image data in units of pictures in this case, the data length of the coded data is determined to be sufficiently long.

If it is determined in Step S106 that the data length of the coded data is longer compared to the threshold value, the processing proceeds to Step S109. In such a case, the data length of the coded data is determined to be sufficiently long.

Accordingly, the memory selecting unit 132 selects the NAND flash memory 122 as a supply destination of the coded data in Step S109. That is, the memory selecting unit 132 supplies the coded data as a target of processing to the NAND flash memory 122 and causes the NAND flash memory 122 to store the coded data (that is, the memory selecting unit 132 records the coded data in the NAND flash memory 122).

If it is determined in Step S108 that the condition for moving the data is satisfied and the coded data recorded in the non-volatile cache memory 123 (the coded data stored on the non-volatile cache memory 123) is to be moved to the NAND flash memory 122, the processing proceeds to Step S109.

In such a case, the memory selecting unit 132 reads the coded data stored on the non-volatile cache memory 123, supplies the coded data to the NAND flash memory 122, and causes the NAND flash memory 122 to store the coded data (that is, the memory selecting unit 132 moves the coded data in the non-volatile cache memory 123 to the NAND flash memory 122) in Step S109.

At that time, the memory selecting unit 132 reads, from the non-volatile cache memory 123, coded data corresponding to the data length which is at least equal to or greater than a writing unit (a page unit, for example) of the NAND flash memory 122 and records the coded data in the NAND flash memory 122. It is possible to record the coded data without forming an unnecessary empty region in the storage region of the NAND flash memory 122 particularly by setting the data length of the coded data to be moved to a multiple integer of the writing unit. That is, it is possible to more efficiently utilize the storage region of the NAND flash memory 122.

In addition, the number of accesses (the number of times of writing) to the NAND flash memory 122 is reduced as the data length of the coded data to be moved increases, and it is possible to expand a period, during which data can be written in the NAND flash memory 122 (a so-called lifetime). In addition, burden of the writing processing is reduced, and an increase in power consumption and an increase in the writing processing time can be suppressed. However, it is necessary to move the data before the free space of the non-volatile cache memory 123 runs short.

When the processing in Step S109 is completed, the recording processing is completed.

The memory storage 111 (SSD) can appropriately control availability of the cache memory in accordance with the data length and efficiently record data regardless of whether or not the data is big data, by the controller 121 executing the recording processing as described above. In doing so, the memory storage 111 can suppress an increase in power consumption, a decrease in a data reading speed and a data writing speed, and a decrease in a period, during which data can be written in a recording medium.

### Memory Storage

In addition, an arbitrary recording medium can be applied to the cache memory of the memory storage 111. For example, a volatile semiconductor memory may be used instead of the non-volatile semiconductor memory.

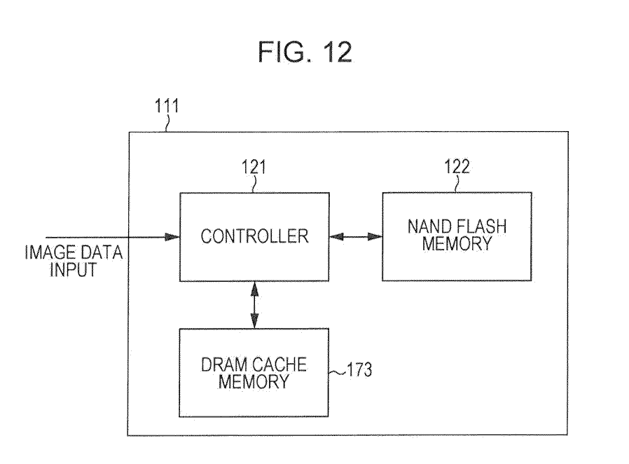

In the example shown in FIG. 12, a Dynamic Random Access Memory (DRAM) cache memory 173 is provided as a cache memory instead of the non-volatile cache memory 123 in the memory storage 111.

The DRAM cache memory 173 has a storage region configured of a DRAM. The DRAM can read and write data at a higher speed compared to the NAND flash memory, and the DRAM cache memory 173 is used as a cache memory in the same manner as in the case of the non-volatile cache memory 123.

The same recording processing as that in the case of the non-volatile cache memory 123 can be also executed in this case, and data can be more efficiently recorded regardless of the data length.

Although the DRAM can be implemented at a relatively lower cost compared to the non-volatile cache memory 123, there is a possibility that stored data is deleted when the power is turned off since the DRAM is a volatile memory device. For this reason, a configuration is also applicable in which the data stored on the DRAM cache memory 173 can be evacuated to the NAND flash memory 122 when the power is disconnected for some reason. Furthermore, the evacuated data may be returned to the DRAM cache memory 173 when the power is turned on thereafter.

However, it typically takes time of several hundreds msec to perform the processing. Furthermore, rewriting in the NAND flash memory 122 advances if the data is evacuated, and there is a possibility that the lifetime of the NAND flash memory 122 is shortened.

It is unnecessary to prepare a countermeasure for such turning-off of the power by using the non-volatile cache memory 123 as the cache memory as in the example shown in FIG. 2.

Although the above description was given of a case where the memory storage 111 includes a single NAND flash memory 122 and a single non-volatile cache memory 123 (or the DRAM cache memory 173) for each controller 121, a single controller 121 may control an arbitrary number of memories. In addition, the cache memory may be configured of a plurality of different memories such as the non-volatile cache memory 123 and the DRAM cache memory 173, for example. The same is true to the memory for saving data, which was described above as a case of the NAND flash memory 122. Furthermore, the memory storage 111 may include a plurality of controllers 121.

### Flow of Recording Processing

Even when it is determined in the recording processing that the coded data has been created in units of tiles or in units of macro-blocks, the data length of the coded data may be compared with a threshold value. In such a case, a threshold value dedicated for each coding unit may be provided.

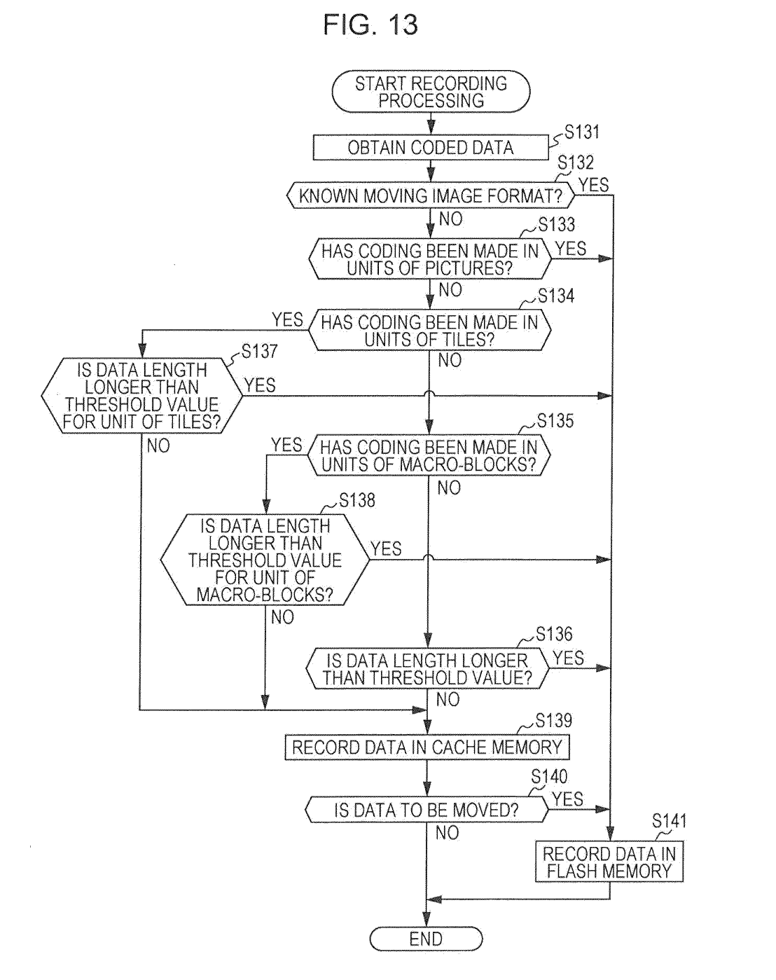

A description will be given of an example of a flow of the recording processing in such a case with reference to the flowchart shown in FIG. 13.

As shown in FIG. 13, the respective processing from Step S131 to Step S136 and from Step S139 to Step S141 in this case are executed basically in the same manner as the respective processing from Step S101 to Step S109 in the example shown in FIG. 11.

However, when it is determined in Step S134 that the coded data has been created by coding the image data in units of tiles, the processing proceeds to Step S137.

In Step S137, the data length detecting unit 143 determines whether or not the data length of the coded data is longer compared to a threshold value for a tile unit, based on the information (the parameter set or the header information, for example) included in the coded data. Then, if it is determined that the data length of the coded data is longer compared to the threshold value for the tile unit, the processing proceeds to Step S141, and the coded data is recorded in the NAND flash memory 122. If it is determined in Step S137 that the data length of the coded data is not longer compared to the threshold value for the tile unit, the processing proceeds to Step S139, and the coded data is recorded in the non-volatile cache memory 123.

It is a matter of course that the data length detecting unit 143 may determine whether or not the data length of the coded data is shorter compared to the threshold value for the tile unit in Step S137. Then, the processing may proceed to Step S139 if it is determined that the data length of the coded data is shorter compared to the threshold value, and the processing may proceed to Step S141 if it is determined that the data length of the coded data is not shorter compared to the threshold value.

If it is determined in Step S135 that the coded data has been created by coding the image data in units of macro-blocks, the processing proceeds to Step S138.

In Step S138, the data length detecting unit 143 determines whether or not the data length of the coded data is longer compared to a threshold value for a macro-block unit, based on the information (the parameter set or the header information, for example) included in the coded data. Then, if it is determined that the data length of the coded data is longer compared to the threshold value for the macro-block unit, the processing proceeds to Step S141, and the coded data is recorded in the NAND flash memory 122. If it is determined in Step S138 that the data length of the coded data is not longer compared to the threshold value for the macro-block unit, the processing proceeds to Step S139, and the coded data is recorded in the non-volatile cache memory 123.

It is a matter of course that the data length detecting unit 143 may determine whether or not the data length of the coded data is shorter compared to the threshold value for the macro-block unit in Step S138. Then, the processing may proceed to Step S139 if it is determined that the data length of the coded data is shorter compared to the threshold value, and the processing may proceed to Step S141 if it is determined that the data length of the coded data is not shorter compared to the threshold value.

Even in such a case, the memory storage 111 (SSD) can appropriately control availability of the cache memory in accordance with the data length and can more efficiently record the data regardless of whether or not the data is big data. In doing so, the memory storage 111 can suppress an increase in power consumption, a decrease in a data writing speed, and a decrease in a period, during which data can be written in the recording medium.

### 2. Second Embodiment

### Line Block

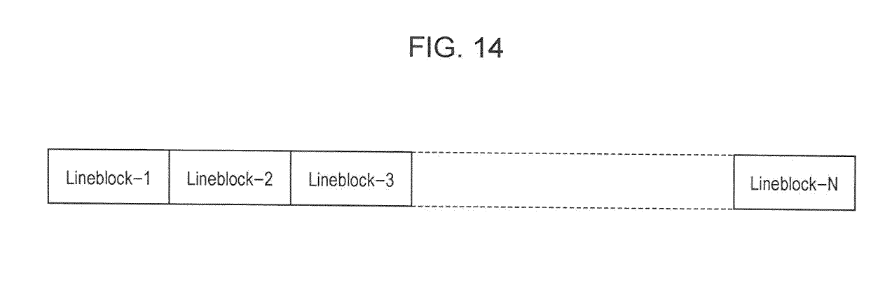

In addition, the coded data may be obtained by coding data in units of line blocks as shown in FIG. 14.

For example, it is possible to implement coding in units of line blocks as shown in FIG. 14 by using a coding technique, in which wavelet transform is performed in units of lines and encoding is performed in units of line blocks.

By using such a coding technique, it is possible to output an initial coded code stream at a delay time corresponding to several tens lines of the image. Accordingly, it is possible to significantly reduce a coding amount in units of encoding compared with a case where one picture is fully transmitted. Therefore, it is preferable to record the data in the non-volatile cache memory 123 when encoding is performed in units of line blocks. As well as the size of data, memory is accessed a number of times corresponding to the number of line blocks, which is several tens per a picture, and data is written in the encoding in units of line blocks compared with a case where one picture is recorded in a memory at the same time. By utilizing the cache memory, it is possible to suppress such an increase in the number of accesses.

### Coding and Decoding in Units of Line Blocks

Hereinafter, a description will be given of a specific example of such coding and decoding techniques.

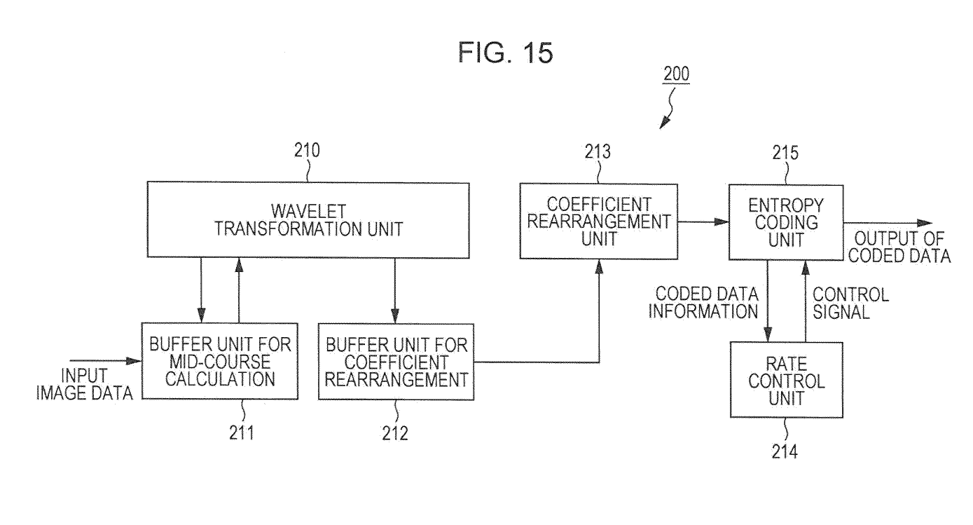

FIG. 15 is a diagram showing an example of a configuration of an image coding apparatus which performs low-delay coding. As shown in FIG. 15, an image coding apparatus 200 in this case includes a wavelet transform unit 210, a buffer unit 211 for mid-course calculation, a buffer unit 212 for coefficient rearrangement, a coefficient rearrangement unit 213, a rate control unit 214, and an entropy coding unit 215.

Image data input to the image coding apparatus 200 (input image data) is temporarily saved in the buffer unit 211 for mid-course calculation. The wavelet transform unit 210 performs wavelet transform on the image data which is saved in the buffer unit 211 for mid-course calculation. That is, the wavelet transform unit 210 reads the image data from the buffer unit 211 for mid-course calculation, performs filtering processing hereon by an analysis filter, generates data on coefficients of a low-frequency component and a high-frequency component, and stores the generated coefficient data on the buffer unit 211 for mid-course calculation. The wavelet transform unit 210 includes a horizontal analysis filter and a vertical analysis filter and performs analysis filtering processing on an image data group in both the horizontal direction of the screen and the vertical direction of the screen. The wavelet transform unit 210 reads again the coefficient data of the low-frequency component which is stored on the buffer unit 211 for mid-course calculation, performs the filtering processing on the read coefficient data by the analysis filter, and further generates data on coefficients of the high-frequency component and the low-frequency component. The generated coefficient data is stored on the buffer unit 211 for mid-course calculation.

If the wavelet transform unit 210 repeats the processing and a decomposition level reaches a predetermined level, the wavelet transform unit 210 reads the coefficient data from the buffer unit 211 for mid-course calculation and writes the read coefficient data in the buffer unit 212 for coefficient rearrangement.

The coefficient rearrangement unit 213 reads the coefficient data, which is written in the buffer unit 212 for coefficient rearrangement, in a predetermined order and supplies the coefficient data to the entropy coding unit 215. The entropy coding unit 215 codes the supplied coefficient data by a predetermined entropy coding scheme such as the Huffman coding scheme or the arithmetic coding scheme.

The entropy coding unit 215 operates in conjunction with the rate control unit 214 and is controlled such that a bit rate of the output compression-coded data is a substantially constant value. That is, the rate control unit 214 supplies, to the entropy coding unit 215, a coding signal for controlling the entropy coding unit 215 to complete the coding processing at a timing, at which the bit rate of the data compression-coded by the entropy coding unit 215 reaches a target value, or a timing immediately before the bit rate reaches the target value, based on coded data information from the entropy coding unit 215. The entropy coding unit 215 outputs the coded data at a timing, at which the coding processing is completed, in response to the control signal supplied from the rate control unit 214.

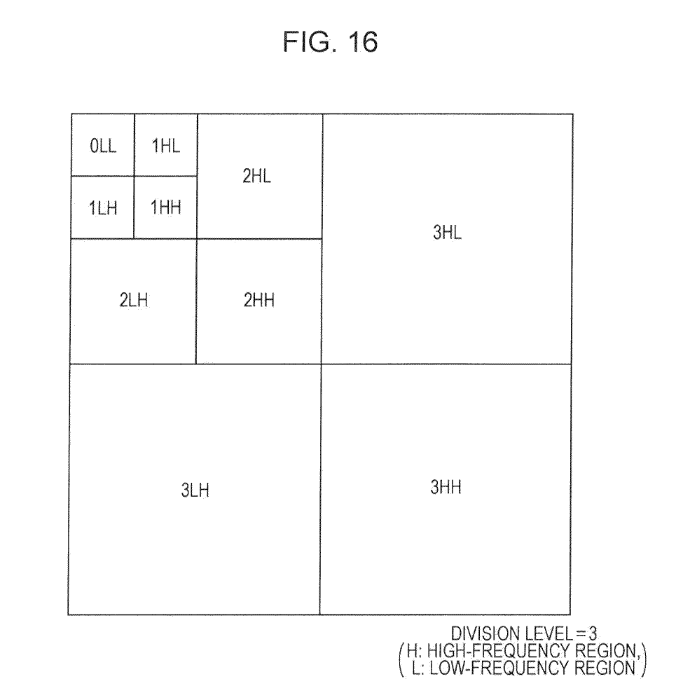

A more detailed description will be given of the processing performed by the wavelet transform unit 210. First, an outline of the wavelet transform will be described. In the wavelet transform performed on image data, processing of dividing the image data into data of high spatial frequency band and data of low spatial frequency band is repeatedly and recursively performed on data of the low spatial frequency band, which is obtained as a result of the division, as schematically shown in FIG. 16. It is possible to efficiently perform compression-coding by tracking down the data of the low spatial frequency band to a smaller region.

In addition, FIG. 16 show an example of a case where the dividing processing of a lowest-frequency component region of the image data into a region L of a low-frequency component and a region H of a high-frequency component is repeated three times and a division level is set to three. In FIG. 16, “L” and “H” represent a low-frequency component and a high-frequency component, respectively, a former one of the order of “L” and “H” represents a frequency band as a result of division in a horizontal direction, and a latter one of the order represents a frequency band as a result of division in the vertical direction. In addition, the numbers before “L” and “H” represent division levels of the regions.

As can be understood from the example shown in FIG. 16, stepwise processing is performed from the lower right region of the screen to the upper left region, and the low-frequency component is tracked down. That is, the lower right region of the screen is a region 3HH with the least low-frequency components (including most high-frequency components), and the upper left region obtained by dividing the screen into four regions is further divided into four regions, and the left upper region of the four divided regions is further divided into four regions in the example of FIG. 16. The upper leftmost region is a region 0LL with the most low-frequency components.

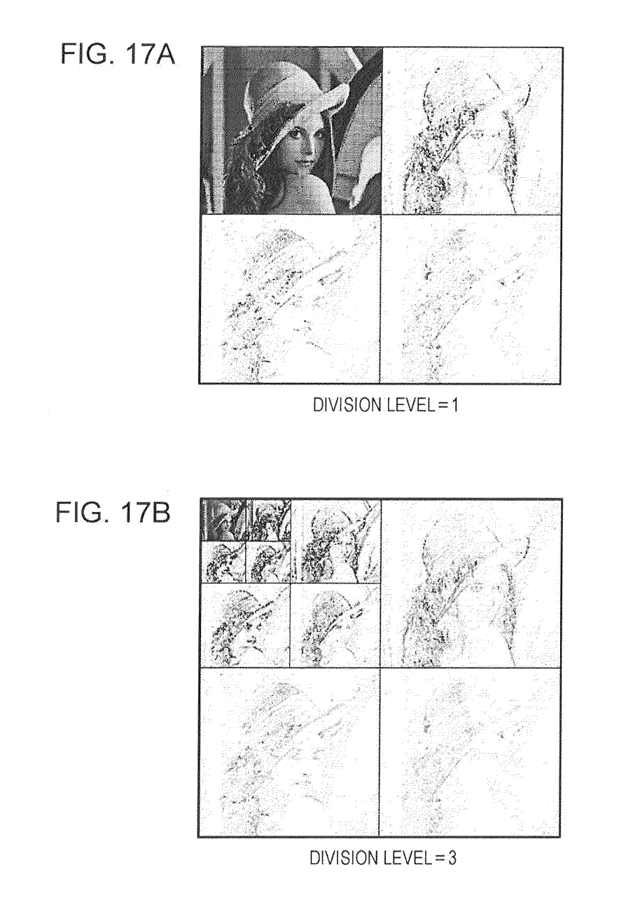

The transform and the division are repeatedly performed on the low-frequency components because energy of the image concentrates on the low-frequency components. This can be understood from a fact that sub-bands are formed as shown in FIG. 17B as the division level increases from a state of the division level=1 in the example shown in FIG. 17A to a state of the division level=3 in the example shown In FIG. 17B. For example, the division level of the wavelet transform in FIG. 16 is 3, and as a result, ten sub-bands are formed.

The wavelet transform unit 210 typically performs the aforementioned processing by using a filter bank configured of a low-frequency filter and a high-frequency filter. Since a digital filter typically has impulse response with a plurality of tap lengths, namely filter coefficients, it is necessary to buffer sufficient input image data and coefficient data for the filtering processing in advance. Similarly, it is also necessary to buffer sufficient wavelet transform coefficients, which are generated in the previous stage, for the filtering processing when the wavelet transform is performed in multiple stages.

Next, a description will be given of a method using a 5×3 filter as a specific example of the wavelet transform based on the coding scheme. The method using the 5×3 filter has been employed by the JPEG 2000 standard which was mentioned in the above description of the related art, and is an excellent method in terms of a point that the wavelet transform can be performed with a small number of filter taps.

The 5×3 filter impulse response (Z transform expression) is configured of a low-frequency filter H₀(z) and a high-frequency filter H₁(z) as represented by the following Equations (1) and (2). It can be understood from Equations (1) and (2) that the low-frequency filter H₀(z) includes five taps and the high-frequency filter H₁(z) includes three taps.

H₀(z)=(−1+2z⁻¹+6z⁻²+2z⁻³−z⁻⁴)/8 (1)

H₁(z)=(−1+2z⁻¹−z⁻²)/2 (2)

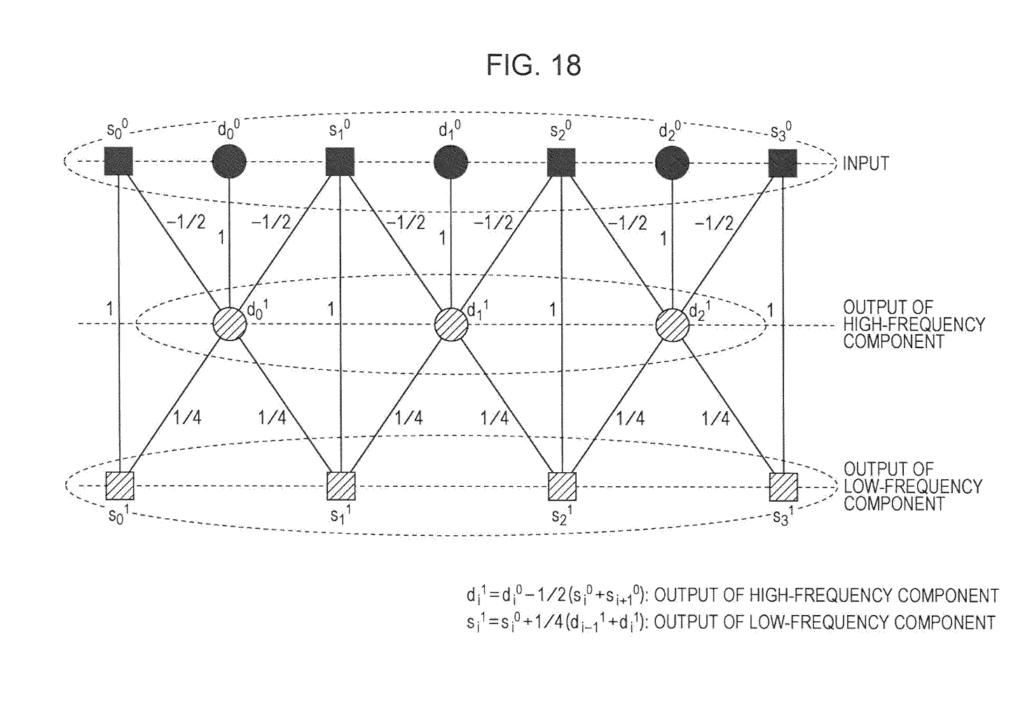

Using Equations (1) and (2), it is possible to directly calculate the coefficients of the low-frequency and high-frequency components. Here, it is possible to reduce the calculation for the filtering processing by using a lifting technique. A description will be given of an outline of processing on a side of the analysis filter which performs the wavelet transform when the lifting technique is applied to the 5×3 filter with reference to FIG. 18.

In FIG. 18, the uppermost part, the middle part, and the lowermost part represent a pixel array of the input image, high-frequency component outputs, and low-frequency component outputs, respectively. The upper most part is not limited to the pixel array of the input image and may be a coefficient obtained by the previous filtering processing. Here, the uppermost part represents the pixel array of the input image, squares (▪) represent pixels or lines of even numbers (the fist pixel is the 0-th pixel), and circles () represent pixels or lines of odd numbers.

First, a high-frequency component coefficient dᵢ¹ is generated from the input pixel array by the following Equation (3) in the first stage.

dᵢ¹=dᵢ²−½(sᵢ⁰+sᵢ₊₁⁰) (3)

Then, the generated high-frequency component coefficient and the pixels of odd numbers in the input image are used to generate a low-frequency component coefficient sᵢ¹ by the following Equation (4) in the second stage.

sᵢ¹=sᵢ⁰+¼(dᵢ₋₁¹+dᵢ¹) (4)

On the side of the analysis filter, the pixel data of the input image is decomposed into the low-frequency components and the high-frequency components by the filtering processing as described above.

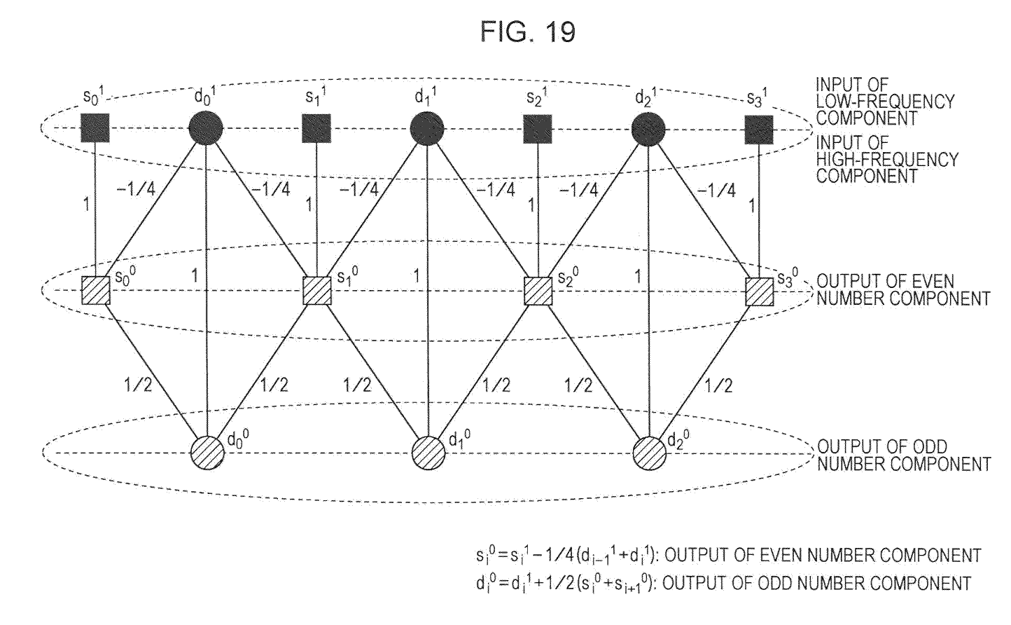

A description will be given of an outline of processing on a side of a synthesis filter which performs wavelet inverse transform for recovering the coefficients generated by the wavelet transform, with reference to FIG. 19. FIG. 19 shows an example in which the 5×3 filter is used in the same manner as in the aforementioned FIG. 18 and the lifting technique is applied. In FIG. 19, the uppermost part represents input coefficients generated by the wavelet transform, circles () represent high-frequency component coefficients, and squares (▪) represent low-frequency component coefficients, respectively.

First, coefficients sᵢ⁰ of even numbers (the first coefficient is 0-th coefficient) are generated from the input low-frequency component and high-frequency component coefficients based on the following Equation (5) in the first stage.

sᵢ⁰=sᵢ¹−¼(dᵢ₋₁¹+dᵢ¹) (5)

Then, coefficients dᵢ⁰ of odd numbers are generated from the coefficients sᵢ⁰ of even numbers generated in the aforementioned first stage and the input high-frequency component coefficients dᵢ¹ based on the following Equation (6) in the second stage.

dᵢ¹=dᵢ¹+½(sᵢ⁰+sᵢ₊₁⁰) (6)

On the side of the synthesis filter, the wavelet inverse transform is performed by synthesizing the low-frequency component and the high-frequency component coefficients by the filtering processing as described above.

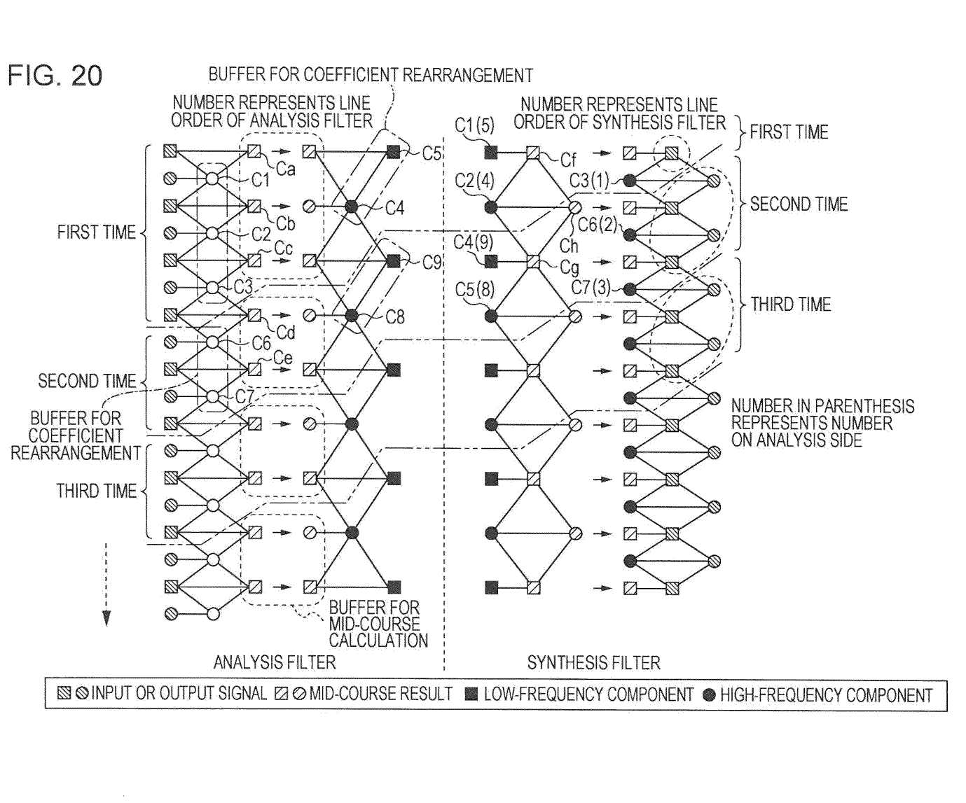

Next, a description will be given of a wavelet transform method. FIG. 20 shows an example in which the filtering processing based on the lifting of the 5×3 filter as described above with reference to FIG. 18 is executed up to the decomposition level=2. In FIG. 20, the left part of the drawing, which is shown as the analysis filter, corresponds to a filter of the wavelet transform unit 210 on the side of the image coding apparatus 200. In addition, the right part of the drawing, which is shown as the synthesis filter, corresponds to the filter of the wavelet inverse transform unit 223 on a side of an image decoding apparatus 220 which will be described later.

It is assumed in the following description that a pixel at the upper left corner of the screen on a display device, for example, is regarded as a top, pixels are scanned from the left end to the right end of the screen to configure one line, and scanning for each line is performed from the upper end to the lower end of the screen to configure one screen.

In FIG. 20, pixel data items located at corresponding positions on lines of original image data are aligned at the left end array in the vertical direction. That is, the filtering processing by the wavelet transform unit 210 is performed by using a vertical filter to scan the pixels on the screen in the vertical direction. Filtering processing for the division level=1 is performed on the first to third arrays from the left end, and the filtering processing for the division level=2 is performed on the fourth to sixth arrays. The second array from the left end corresponds to high-frequency component outputs based on pixels of the original image data at the left end, and the third array from the left end corresponds to low-frequency component outputs based on the original image data and the high-frequency component outputs. The filtering processing for the division level=2 is performed on the outputs of the filtering processing for the division level=1 as shown at the fourth to sixth arrays from the left end.

In the filtering processing of the decomposition level=1, high-frequency component coefficient data is calculated based on the pixels of the original image data in the first stage of the filtering processing, and low-frequency component coefficient data is then calculated based on the high-frequency component coefficient data calculated in the first stage of the filtering processing and the pixels of the original image data in the second stage of the filtering processing. An example of the filtering processing of the decomposition level=1 will be shown at the first to third arrays on the left side (the side of the analysis filter) in FIG. 20. The calculated high-frequency component coefficient data is stored on the buffer unit 212 for coefficient rearrangement as described above with reference to FIG. 15. In addition, the calculated low-frequency component coefficient data is stored on the buffer unit 211 for mid-course calculation.

In FIG. 20, the buffer unit 212 for coefficient rearrangement is shown as a part surrounded by a one-dotted chain line, and the buffer unit 211 for mid-course calculation is shown as a part surrounded by a dotted line.

Filtering processing of the decomposition level=2 is performed based on the result of the filtering processing of the decomposition level=1 which is maintained in the buffer unit 211 for mid-course calculation. In the filtering processing of the decomposition level=2, the coefficient data calculated as low-frequency component coefficients in the filtering processing of the decomposition level=1 is regarded as coefficient data which includes the low-frequency components and the high-frequency components, and the same filtering processing as that of the decomposition level=1 is performed. The high-frequency component coefficient data and the low-frequency component coefficient data calculated by the filtering processing of the decomposition level=2 are stored on the buffer unit 212 for coefficient rearrangement as described above with reference to FIG. 15.

The wavelet transform unit 210 performs the aforementioned filtering processing in both the horizontal direction and the vertical direction of the screen. First, the filtering processing of the decomposition level=1 is performed in the horizontal direction, and the generated high-frequency component coefficient data and the low-frequency component coefficient data are stored on the buffer unit 211 for mid-course calculation, for example. Then, the filtering processing of the decomposition level=1 in the vertical direction is performed on the coefficient data stored on the buffer unit 211 for mid-course calculation. By the processing of the decomposition level=1 in the horizontal and vertical directions, four regions namely a region HH and a region HL of coefficient data items respectively obtained by further decomposing the high-frequency components into high-frequency components and low-frequency components and a region LH and a region LL of coefficient data items respectively obtained by further decomposing the low-frequency components into high-frequency components and low-frequency components are formed.

Then, the filtering processing of the decomposition level=2 is performed on the low-frequency component coefficient data generated by the filtering processing of the decomposition level=1 in both the horizontal direction and the vertical direction. That is, the region LL formed by dividing the low-frequency component in the filtering processing of the decomposition level=1 is further divided into the four regions, and a region HH, a region HL, a region LH, and a region LL are further formed in the region LL in the filtering processing of the decomposition level=2.

According to the coding scheme, the filtering processing based on the wavelet transform is performed a plurality of times in a stepwise manner by dividing the filtering processing into processing for every several lines in the vertical direction of the screen. In the example shown in FIG. 20, the filtering processing is performed on seven lines in the first processing performed from the first line on the screen, and the filtering processing is then performed on every four lines in the second and the following processing from the eighth line. The number of lines is based on the necessity to generate the lowest-frequency components corresponding to one line after division into two regions of high-frequency components and low-frequency components.

In the following description, a group of lines including other sub-bands, which are necessary to generate the lowest-frequency components corresponding to one line (coefficient data corresponding to one line of a sub-band of the lowest-frequency components) will be referred to as a line block (or precinct). Here, a line represents pixel data or coefficient data corresponding to one row formed in a picture or a field corresponding to the image data before the wavelet transform or in each sub-band. That is, a line block (precinct) represents a pixel data group corresponding to a number of lines, which are necessary to generate coefficient data corresponding to one line of the sub-band of the lowest-frequency components after the wavelet transform, in the original image data before the wavelet transform or a coefficient data group of each sub-band obtained by performing wavelet transform on the pixel data group.

In FIG. 20, a coefficient C5 which is obtained as a result of the filtering processing of the decomposition level=2 is calculated based on a coefficient C4 and a coefficient Ca which is stored on the buffer unit 211 for mid-course calculation, and the coefficient C4 is calculated based on the coefficient Ca, a coefficient Cb, and a coefficient Cc which are stored on the buffer unit 211 for mid-course calculation. Furthermore, the coefficient Cc is calculated based on a coefficient C2 and a coefficient C3 which are stored on the buffer unit 212 for coefficient rearrangement and pixel data of the fifth line. In addition, the coefficient C3 is calculated based on the pixel data of the fifth line to the seventh line. As described above, pixel data of the first line to the seventh line is necessary to obtain the low-frequency component coefficient C5 of the decomposition level=2.

In contrast, it is possible to use the coefficient data which has been already calculated by the previous filtering processing and stored on the buffer unit 212 for coefficient rearrangement for the second and the following filtering processing, and therefore, the number of necessary lines is small.

That is, a coefficient C9 which is the next coefficient of the coefficient C5 is calculated based on the coefficient C4, a coefficient C8, and a coefficient Cc which is stored on the buffer unit 211 for mid-course calculation among the low-frequency component coefficients obtained as a result of the filtering processing of the decomposition level=2 in FIG. 20. The coefficient C4 has been already calculated by the aforementioned first filtering processing and saved on the buffer unit 212 for coefficient rearrangement. Similarly, the coefficient Cc has been already calculated by the aforementioned first filtering processing and stored on the buffer unit 211 for mid-course calculation. Therefore, only the filtering processing for calculating the coefficient C8 is newly performed in the second filtering processing. The new filtering processing is performed by further using the eighth to eleventh lines.

Since it is possible to use data which has been calculated in the previous filtering processing and stored on the buffer unit 211 for mid-course calculation and the buffer unit 212 for coefficient rearrangement in the second and the following filtering processing as described above, processing is performed merely on every four lines.

In addition, when the number of lines on the screen does not coincide with the number of coded lines, the lines of the original image data are copied such that the number of lines coincide with the number of coded lines, and the filtering processing is performed.

Although a detailed description will be given later, the present disclosure makes it possible to obtain a decoded image with low delay when coded data is transmitted, by performing, in a stepwise manner, the filtering processing for obtaining coefficient data corresponding to one line of the lowest-frequency components on the lines on the entire screen over a plurality of times (in units of line blocks).

In order to perform the wavelet transform, it is necessary to prepare a first buffer which is used to execute the wavelet transform itself and a second buffer which is for storing coefficients generated during execution of the processing up to a predetermined division level. The first buffer corresponds to the buffer unit 211 for mid-course calculation and is shown by being surrounded at a dotted line in FIG. 20. In addition, the second buffer corresponds to the buffer unit 212 for coefficient rearrangement and is shown by being surrounded by a one-dotted chain line in FIG. 20. The coefficients stored on the second buffer are used for the decoding and therefore regarded as targets of entropy coding processing in the later stage.

A description will be given of processing of the coefficient rearrangement unit 213. The coefficient data calculated by the wavelet transform unit 210 is stored on the buffer unit 212 for coefficient rearrangement, and the coefficients are read while the order thereof is rearranged by the coefficient rearrangement unit 213 and are sent to the entropy coding unit 215 as described above.

As already described above, the coefficients are generated from the side of the high-frequency components to the side of the low-frequency components in the wavelet transform. In the example shown in FIG. 20, the coefficient C1, the coefficient C2, and the coefficient C3 of the high-frequency components are sequentially generated by the first filtering processing of the decomposition level=1 from the pixel data of the original image. Then, the filtering processing of the decomposition level=2 is performed on the low-frequency component coefficient data obtained by the filtering processing of the decomposition level=1, and the coefficient C4 and the coefficient C5 of the low-frequency components are sequentially generated. That is, the coefficient data is generated in an order of the coefficient C1, the coefficient C2, the coefficient C3, the coefficient C4, and the coefficient C5 in the first filtering processing. The generation order of the coefficient data is necessarily this order (the order from the high-frequency components to the low-frequency components) due to a principle of the wavelet transform.

In contrast, it is necessary to generate and output an image from the low-frequency components in order to immediately decode data with low delay on the decoding side. For this reason, it is desired that the coefficient data generated on the coding side be rearranged in an order from the side of the lowest-frequency components to the side of the high-frequency components and supplied to the decoding side.

The more specific description will be given with reference to the example shown in FIG. 20. The right part of FIG. 20 shows the side of the synthesis filter which performs the wavelet inverse transform. The first synthesis processing (wavelet inverse transform processing) including the first line of the output image data on the decoding side is performed by using the coefficient C4 and the coefficient C5 of the lowest-frequency components generated by the first filtering processing on the coding side and the coefficient C1.

That is, in the first synthesis processing, the coefficient data is supplied from the coding side to the decoding side in an order of the coefficient C5, the coefficient C4, and the coefficient C1, and the synthesis processing of a synthesis level=2, which is synthesis processing corresponding to the decomposition level=2, is performed on the coefficient C5 and the coefficient C4 to generate a coefficient Cf and the generated coefficient Cf is stored on the buffer on the decoding side. Then, the synthesis processing of the synthesis level=1, which is synthesis processing corresponding to the decomposition level=1, is performed on the coefficient Cf and the coefficient C1, and a first line is output.

As described above, the coefficient C1, the coefficient C2, the coefficient C3, the coefficient C4, and the coefficient C5 are generated in this order on the coding side, and the coefficient data stored on the buffer unit 212 for coefficient rearrangement is rearranged in an order of the coefficient C5, the coefficient C4, the coefficient C1, . . . and supplied to the decoding side in the first synthesis processing.

On the side of the synthesis filter shown on the right side of FIG. 20, the coefficients supplied from the coding side are shown with numbers of the coefficients on the coding side inside parentheses and with the line orders of the synthesis filter outside the parentheses. For example, an expression of a coefficient C1(5) means that the coefficient corresponds to the coefficient C5 on the side of the analysis filter on the left side of FIG. 17 and corresponds to the first line on the side of the synthesis filter.

The synthesis processing on the decoding side based on the coefficient data which is generated by the second and the following filtering processing on the coding side can be performed by using the coefficient data which is synthesized by the previous synthesis processing or supplied from the coding side. In the example shown in FIG. 20, it is necessary to further use the coefficient C2 and the coefficient C3 which are generated by the first filtering processing on the coding side for the second synthesis processing on the decoding side, which is performed by using the coefficient C8 and the coefficient C9 of the low-frequency component generated by the second filtering processing on the coding side, and the second line to the fifth line are decoded.

That is, the coefficient data is supplied from the coding side to the decoding side in an order of the coefficient C9, the coefficient C8, the coefficient C2, and the coefficient C3 in the second synthesis processing. On the decoding side, a coefficient Cg is generated by using the coefficient C8, the coefficient C9, and the coefficient C4 which is supplied from the coding side at the time of the first synthesis processing in the processing of the synthesis level=2, and the coefficient Cg is stored on the buffer. A coefficient Ch is generated by using the coefficient Cg, the aforementioned coefficient C4, and the coefficient Cf which is generated by the first synthesis processing and stored on the buffer, and the coefficient Ch is stored on the buffer.

Then, the processing of the synthesis level=1 is performed by using the coefficient Cg and the coefficient Ch which are generated by the processing of the synthesis level=2 and stored on the buffer and the coefficient C2 (which is shown as C6(2) on the side of the synthesis filter) and the coefficient C3 (which is shown as C7(3) on the side of the synthesis filter) which are supplied from the coding side, and the second line to the fifth line are decoded.

As described above, the coefficient data which is generated in the order of the coefficient C2, the coefficient C3, (the coefficient C4, the coefficient C5), the coefficient C6, the coefficient C7, the coefficient C8, and the coefficient C9 on the coding side is rearranged in the order of the coefficient C9, the coefficient C8, the coefficient C2, the coefficient C3, . . . and supplied to the decoding side in the second synthesis processing.

The third and the following synthesis processing is performed in the same manner, the coefficient data stored on the buffer unit 212 for coefficient rearrangement is rearranged in a predetermined order and supplied to the decoding unit, and decoding is performed on every four lines.

In addition, since all the coefficient data items generated in the previous processing and stored on the buffer are output in the synthesis processing on the decoding side, which corresponds to the filtering processing including the lines of the lower end of the screen on the coding side (hereinafter, referred to as a final processing), the number of output lines increases. In the example shown in FIG. 20, eight lines are output by the final processing.

In addition, the coefficient data rearrangement processing by the coefficient rearrangement unit 213 is performed by setting a reading address, which is for reading the coefficient data stored on the buffer unit 212 for coefficient rearrangement, in a predetermined order, for example.

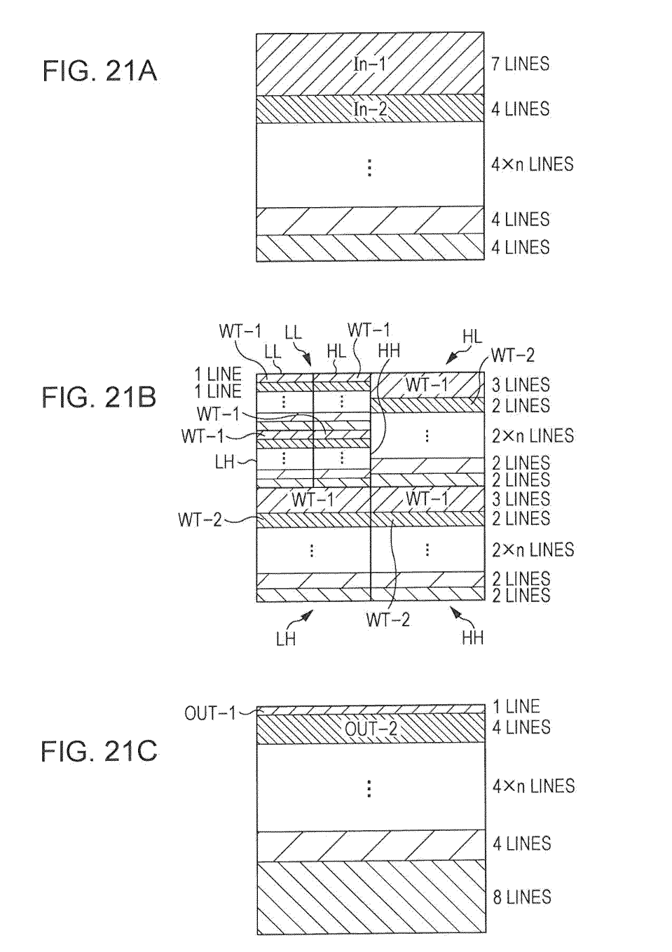

A more specific example will be given of the aforementioned processing with reference to FIG. 21. FIG. 21 shows an example in which the filtering processing based on the wavelet transform is performed up to the decomposition level=2 by using the 5×3 filter. The wavelet transform unit 210 performs the first filtering processing on the first to seventh lines of the input image data in both the horizontal and vertical directions as shown as an example in FIG. 21A (In-1 in FIG. 21A).

The coefficient data corresponding to three lines, namely the coefficient C1, the coefficient C2, and the coefficient C3 is generated in the processing of the decomposition level=1 of the first filtering processing, and the coefficient data is arranged in the region HH, the region HL, and the region LH, respectively, which are formed by the processing of the decomposition level=1 as shown as an example in FIG. 21B (WT-1 in FIG. 21B).

In addition, the region LL formed by the processing of the decomposition level=1 is further divided into four regions by the filtering processing of the decomposition level=2 in the horizontal and vertical directions. As for the coefficient C5 and the coefficient C4 generated by the processing of the decomposition level=2, one line by the coefficient C5 is arranged in the region LL, and one line by the coefficient C4 is arranged in each of the region HH, the region HL, and the region LH inside the region LL which is generated by the processing of the decomposition level=1.

In the second and the following filtering processing by the wavelet transform unit 210, the filtering processing is performed on every four lines (In-2 . . . in FIG. 21A), coefficient data corresponding to two lines is generated by the processing of the decomposition level=1 (WT-2 in FIG. 21B), and coefficient data corresponding to one line is generated by the processing of the decomposition level=2.

In the second processing of the example shown in FIG. 20, coefficient data corresponding to two lines, namely the coefficient C6 and the coefficient C7 is generated by the filtering processing of the decomposition level=1, and coefficient data after the coefficient data generated by the first filtering processing performed on the region HH, the region HL, and the region LH which are formed by the filtering processing of the decomposition level=1 is arranged as shown as an example in FIG. 21B. Similarly, the coefficient C9 corresponding to one line generated by the filtering processing of the decomposition level=2 is arranged in the region LL, and the coefficient C8 corresponding to one line is arranged in each of the region HH, the region HL, and the region LH inside the region LL generated by the processing of the decomposition level=1.

When the data which has been subjected to the wavelet transform as shown in FIG. 21B is decoded, the first line by the first synthesis processing on the decoding side is output with respect to the first filtering processing performed on the first line to the seventh line on the coding side as shown as an example in FIG. 21C (Out-1 in FIG. 21C). Thereafter, every four lines are output on the decoding side with respect to the second filtering processing to the filtering processing before the last filtering processing on the coding side (Out-2 . . . in FIG. 21C). Then, eight lines are output on the decoding side with respect to the last filtering processing on the coding side.

The coefficient data generated from the side of the high-frequency components to the side of the low-frequency components by the wavelet transform unit 210 is sequentially stored on the buffer unit 212 for coefficient rearrangement. The coefficient rearrangement unit 213 rearranges the coefficient data in an order necessary for the synthesis processing and reads the coefficient data from the buffer unit 212 for coefficient rearrangement when sufficient coefficient data for performing the aforementioned rearrangement of the coefficient data is accumulated in the buffer unit 212 for coefficient rearrangement. The read coefficient data is sequentially supplied to the entropy coding unit 215.

The entropy coding unit 215 performs entropy coding on the supplied coefficient data by controlling a coding operation such that a bit rate of output data becomes a target bit rate, based on a control signal supplied from the rate control unit 214. The coded data after the entropy coding is supplied to the decoding side. As a coding scheme, a known technique such as the Huffman coding or the arithmetic coding can be considered. It is a matter of course that the coding scheme is not limited thereto, and another coding scheme may also be used as long as invertible coding processing can be performed.

In addition, it is possible to expect further improvement in the compression effect if the entropy coding unit 215 first quantizes the coefficient data read from the coefficient rearrangement unit 213 and information source coding processing such as the Huffman coding or the arithmetic coding is performed on the obtained quantized coefficients. Any quantizing method may be used, and for example, a general method, namely a method of dividing coefficient data W by a quantization step size Δ as represented by the following Equation (7) may be used.

Quantized coefficient=W/Δ (7)

As described above with reference to FIGS. 20 and 21, the wavelet transform unit 210 performs the wavelet transform on a plurality of lines (each line block) of the image data in this case. The entropy coding unit 215 outputs coded data of each line block. That is, when the aforementioned 5×3 filter is used and the processing is performed up to the decomposition level=2, an output of one line is obtained by the first processing, outputs of every four lines are obtained by the second processing to the processing before the last processing, and outputs of eight lines are obtained by the last processing in relation to the outputs of the data of one screen.

When the entropy coding is performed on the coefficient data after the rearrangement by the coefficient rearrangement unit 213, a past line, namely a line, for which the coefficient data has already been generated, is not yet present at the time of performing the entropy coding on a line of the first coefficient C5 in the first filtering processing shown in FIG. 20, for example. Therefore, the entropy coding is performed only on the one line in this case. On the other hand, the lines of the coefficient C5 and the coefficient C4 are the past lines at the time of coding the line of the coefficient C1. Since such a plurality of adjacent lines are considered to be configured of similar data, it is effective to collectively perform the entropy coding on the plurality of lines.

Although the above description was given of the example in which the wavelet transform unit 210 performs the filtering processing based on the wavelet transform by using the 5×3 filter, the present disclosure is not limited to this example. For example, the wavelet transform unit 210 can use a filter with a longer tap number such as a 9×7 filter. Since the number of lines accumulated in the filter increases as the tap number of the filter increases in this case, delay time from an input of image data to an output of coded data increases.

Although the above description was given for the purpose of explanation in which the decomposition level of the wavelet transform was 2, the present disclosure is not limited thereto, and it is possible to set a higher decomposition level. As the decomposition level increases, the higher compression rate can be implemented. For example, filter processing is typically repeated up to the decomposition level=4, for example, in the wavelet transform. As the decomposition level increases, the delay time also increases.

For this reason, it is preferable to determine the tap number of the filter and the decomposition level in accordance with the desired delay time and decoded image quality for the information processing system 100. The tap number of the filter and the decomposition level may not be fixed values and can be adaptively selected.

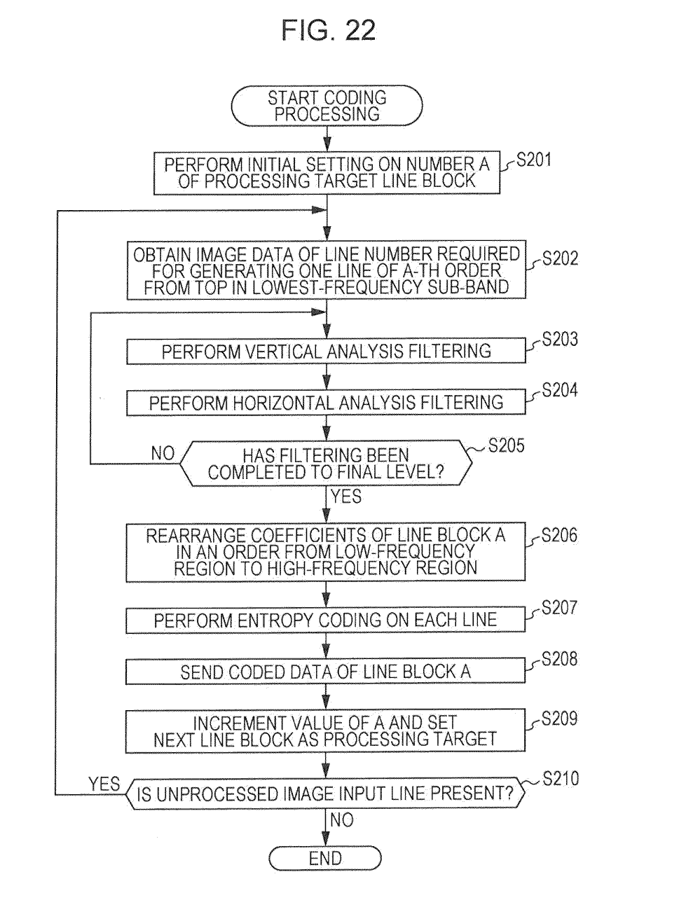

Next, a description will be given of an example of a specific flow of the entire coding processing by the aforementioned image coding apparatus 200 with reference to the flowchart in FIG. 22.

If the coding processing is started, the wavelet transform unit 210 sets a number A of a processing target line block to an initial number in Step S201. Typically, the number A is set to “1”. If the setting is completed, the wavelet transform unit 210 obtains image data of a necessary number of lines (that is, one line block) to generate an A-th line from the top at the lowest-frequency sub-band in Step S202, performs vertical analysis filtering processing, which is for performing analysis filtering processing on image data aligned in the vertical direction of the screen, on the image data in Step S203, and performs horizontal analysis filtering processing, which is for performing analysis filtering processing on image data aligned in the horizontal direction of the screen, on the image data in Step S204.

The wavelet transform unit 210 determines whether or not the analysis filtering processing has been performed up to the final level in Step S205, and if it is determined that the decomposition level has not reached the final level, then the wavelet transform unit 210 returns the processing to Step S203 and repeats the analysis filtering processing in Steps S203 and S204 on the current decomposition level.

If it is determined in Step S205 that the analysis filtering processing has been performed up to the final level, the wavelet transform unit 210 moves on processing in Step S206.

In Step S206, the coefficient rearrangement unit 213 rearranges coefficients of a line block A (the A-th line block from the top of a picture (a field for the interlace scheme)) in an order from low-frequency components to high-frequency components. In Step S207, the entropy coding unit 215 performs the entropy coding on the coefficients for each line. When the entropy coding is completed, the entropy coding unit 215 sends the coded data of the line block A to the outside in Step S208.

The wavelet transform unit 210 increments the value of the number A by “1” and regards the next line block as a processing target in Step S209, determines whether or not an unprocessed image input line is present in a picture (a field in the case of the interlace scheme) of a processing target in Step S210, and if it is determined that the unprocessed image input line is present, then the wavelet transform unit 210 returns the processing to Step S202 and repeats the following processing on the line block as a new processing target.

The processing from Step S202 to Step S210 is repeatedly executed as described above, and the respective line blocks are coded. Then, if it is determined in Step S210 that the unprocessed image input line is not present, the wavelet transform unit 210 completes the coding processing on the picture. The coding processing is newly started for the next picture.

For a wavelet transform method in the related art, the horizontal analysis filtering processing is first performed on an entire picture (a field in the case of the interlace scheme), and the vertical analysis filtering processing is then performed on the entire picture. Then, the same horizontal analysis filtering processing and the vertical analysis filtering processing are sequentially performed on entire obtained low-frequency components. The analysis filtering processing is recursively repeated until the decomposition level reaches the final level as described above. Therefore, it is necessary to cause the buffer to maintain results of the respective analysis filtering processing, and at that time, it is necessary for the buffer to maintain filtering results of an entire picture (a field in the case of the interlace scheme) or filtering results of entire low-frequency components of the decomposition level at that time, and it is necessary to prepare large memory capacity (the data amount to be maintained is large).

In this case, the coefficient rearrangement and the entropy coding in the later stage are not performed if the wavelet transform is not completed in a picture (a field in the case of the interlace scheme), and delay time increases.

On the other hand, since the vertical analysis filtering processing and the horizontal analysis filtering processing are successively performed in units of line blocks up to the final level as described above in the case of the wavelet transform unit 210 of the image coding apparatus 200, the data amount necessary to be maintained (buffered) at the same time (during the same period) is small, and the memory amount of the buffer to be prepared can be significantly reduced compared with the method in the related art. In addition, it is possible to perform the processing in the later stage, such as the coefficient rearrangement or the entropy coding (that is, it is possible to perform the coefficient rearrangement and the entropy coding in units of line blocks) by performing the analysis filtering processing up to the final level. For this reason, it is possible to significantly reduce delay time compared with the method in the related art.

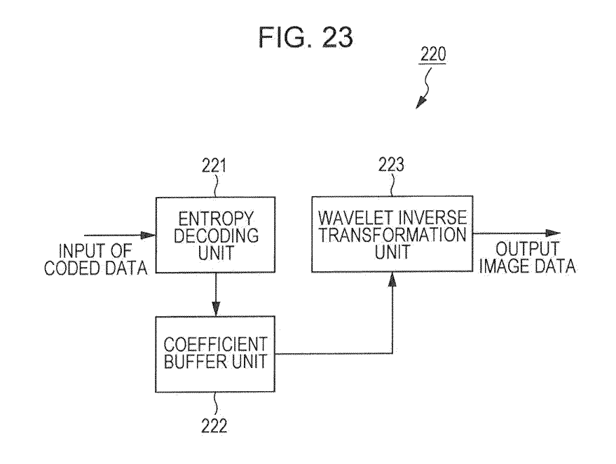

FIG. 23 shows a configuration of an example of the image decoding apparatus 220. Coded data (coded data output in FIG. 15) output from the entropy coding unit 215 of the image coding apparatus 200 is supplied to an entropy decoding unit 221 of the image decoding apparatus 220 shown in FIG. 23 (coded data input in FIG. 23), the entropy coding is decoded, and coefficient data is obtained. The coefficient data is stored on a coefficient buffer unit 222. The wavelet inverse transform unit 223 uses the coefficient data stored on the coefficient buffer unit 222 to perform synthesis filtering processing by the synthesis filter as described above with reference to FIGS. 19 and 20, for example, and stores results of the synthesis filtering processing again on the coefficient buffer unit 222. The wavelet inverse transform unit 223 repeats the processing in accordance with the decomposition level and obtains decoded image data (output image data).

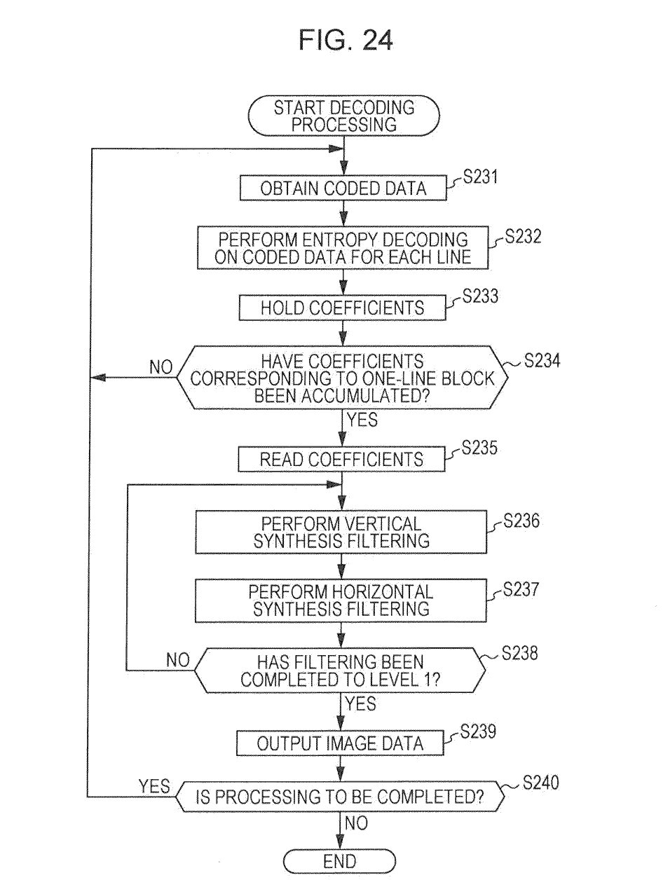

Next, a description will be given of an example of specific flow of the entire decoding processing by the image decoding apparatus 220 as described above with reference to the flowchart in FIG. 24.

If the decoding processing is started, the entropy decoding unit 221 obtains coded data in Step S231 and performs entropy decoding on the coded data for each line in Step S232. In Step S233, the coefficient buffer unit 222 maintains the coefficients obtained by the decoding. The wavelet inverse transform unit 223 determines whether or not coefficients corresponding to one line block have been accumulated in the coefficient buffer unit 222 in Step S234, and if it is determined that the coefficients have not been accumulated, then the wavelet inverse transform unit 223 returns the processing to Step S231, executes the following processing, and stands-by until the coefficients corresponding to one line block are accumulated in the coefficient buffer unit 222.

If it is determined in Step S234 that the coefficients corresponding to one line block have been accumulated in the coefficient buffer unit 222, the wavelet inverse transform unit 223 moves on processing in Step S235 and reads the coefficients corresponding to one line block, which are maintained in the coefficient buffer unit 222.

Then, the wavelet inverse transform unit 223 performs vertical synthesis filtering processing, which is for performing synthesis filtering processing on coefficients aligned in the vertical direction of the screen, on the read coefficients in Step S236, performs horizontal synthesis filtering processing, which is for performing synthesis filtering processing on coefficients aligned in the horizontal direction of the screen, on the coefficients in Step S237, determines whether or not the synthesis filtering processing has been completed up to the level 1 (the level, in which the value of the decomposition level is “1”) in Step S238, that is, whether or not the inverse transform has been performed up to a state before the wavelet transform, and if it is determined that the decomposition level has not reached the level 1, then the wavelet inverse transform unit 223 returns the processing to Step S236 and repeats the filtering processing in Steps S236 and S237.

If it is determined in Step S238 that the inverse transform processing has been completed up to the level 1, the wavelet inverse transform unit 223 moves on processing in Step S239 and outputs the image data obtained by the inverse transform processing to the outside.

The entropy decoding unit 221 determines whether or not to complete the decoding processing in Step S240, and if it is determined that the decoding processing is not to be completed since the input of the coded data continues, then the entropy decoding unit 221 returns the processing to Step S231 and repeats the following processing. If it is determined in Step S240 that the decoding processing is to be completed since the input of the coded data has been completed, then the entropy decoding unit 221 completes the decoding processing.

For a wavelet inverse transform method in the related art, the horizontal synthesis filtering processing is first performed on the entire coefficients of the processing target decomposition level in the horizontal direction of the screen, and the vertical synthesis filtering processing is then performed thereon in the vertical direction of the screen. That is, it is necessary to cause the buffer to maintain results of the synthesis filtering processing every time the synthesis filtering processing is performed, and at that time, it is necessary for the buffer to maintain synthesis filtering results of the decomposition level at that time and all the coefficients of the next decomposition level, and it is necessary to prepare large memory capacity (the data amount to be maintained is large).

In this case, image data is not output until the wavelet inverse transform is completely performed in a picture (a field in the case of the interlace scheme), and therefore, delay time from the input to the output increases.

On the other hand, since the vertical synthesis filtering processing and the horizontal synthesis filtering processing are successively performed in units of line blocks up to the level=1 as described above in the case of the wavelet inverse transform unit 223 of the image decoding apparatus 220, the data amount necessary to be buffered at the same time (during the same period) is small, and the memory amount of the buffer to be prepared can be significantly reduced as compared with the method in the related art. In addition, it is possible to sequentially output the image data (in units of line blocks) before all the image data in the picture is obtained by performing the synthesis filtering processing (wavelet inverse transform processing) up to the level 1 and to thereby significantly reduce delay time as compared with the method in the related art.

In addition, operations of the respective elements in the image coding apparatus 200 and the image decoding apparatus 220 (the coding processing in FIG. 22 and the decoding processing in FIG. 24) are controlled by a Central Processing Unit (CPU) which is not shown in the drawing, for example, based on a predetermined program. The program is stored in advance on a Read Only Memory (ROM) which is not shown in the drawing, for example. The present disclosure is not limited thereto, and it is also possible to configure the respective elements of the image coding apparatus and the image decoding apparatus to operate as a whole by exchanging timing signals and control signals. In addition, the image coding apparatus and the image decoding apparatus can be implemented as software which operates on a computer device.

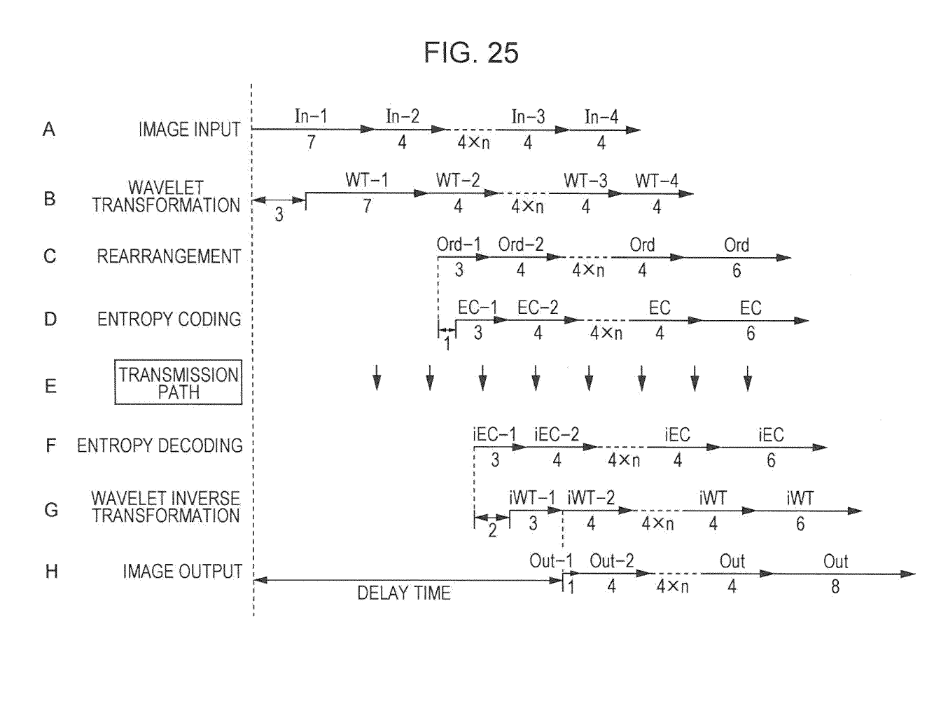

FIGS. 25A to 25H are diagrams schematically showing an example of parallel operations of the respective elements of the image coding apparatus 200 and the image decoding apparatus 220. FIGS. 25A to 25H correspond to the aforementioned FIG. 21. The entropy coding unit 215 performs the first wavelet transform WT-1 (FIG. 25B) on the input In-1 (FIG. 25A) of the image data. As described above with reference to FIG. 20, the first wavelet transform WT-1 is started at a timing, at which the first three lines are input, and the coefficient C1 is generated. That is, delay corresponding to three lines occurs until the wavelet transform WT-1 is started after the input of the image data In-1.

The generated coefficient data is stored on the buffer unit 212 for coefficient rearrangement. Hereinafter, the wavelet transform is performed on the input image data, and processing moves on to the second wavelet transform WT-2 after completion of the first processing.

Rearrangement Ord-1 of three coefficients, namely the coefficient C1, the coefficient C4, and the coefficient C5 is executed by the coefficient rearrangement unit 213 in parallel with the input of the image data In-2 for the second wavelet transform WT-2 and the processing of the second wavelet transform WT-2 (FIG. 25C).

The delay until the rearrangement Ord-1 is started after the completion of the wavelet transform WT-1 is delay based on configurations of the apparatus and the system, such as delay accompanying with delivery of a control signal for instructing the coefficient rearrangement unit 213 to perform the rearrangement processing, delay which is caused when the coefficient rearrangement unit 213 starts the processing in response to the control signal, or delay which is caused when the program processing is performed, and is not inherent delay due to the coding processing.

The coefficient data is read from the buffer unit 212 for coefficient rearrangement in an order, in which the rearrangement is completed, supplied to the entropy coding unit 215, and subjected to entropy coding EC-1 (FIG. 25D). The entropy coding EC-1 can be started without waiting for the completion of the rearrangement of all the three coefficients, namely the coefficient C1, the coefficient C4, and the coefficient C5. For example, it is possible to start the entropy coding on the coefficient C5 at a timing, at which the rearrangement of one line by the initially output coefficient C5 is completed. In such a case, delay until the processing of the entropy coding EC-1 is started after the start of the processing of the rearrangement Ord-1 corresponds to one line.

The coded data after the completion of the entropy coding EC-1 by the entropy coding unit 215 is transmitted to the image decoding apparatus 220 via some transmission path (FIG. 25E). As the transmission path, through which the coded data is transmitted, a communication network such as the Internet can be considered, for example. In such a case, the coded data is transmitted by an Internet protocol (IP). The present disclosure is not limited thereto, and a communication interface such as a Universal Serial Bus (USB) or an Institute Electrical and Electronics Engineers 1394 (IEEE 1394) or wireless communication, representative examples of which include the IEEE 802.11 standard, can be also considered as the transmission path of the coded data.

The inputs of the image data corresponding to seven lines by the first processing to the image coding apparatus 200 are followed by sequential inputs of image data up to the line at the lower end of the screen. The image coding apparatus 200 performs wavelet transform WT-n, rearrangement Ord-n, and entropy coding EC-n on every four lines as described above in response to an input In-n (n is a number which is equal to or greater than two) of the image data. Rearrangement Ord and entropy coding Ec in the final processing by the image coding apparatus 200 are performed on six lines. The processing is performed in parallel by the image coding apparatus 200 as shown as an example in FIGS. 25A to 25D.

The coded data which is coded in the entropy coding EC-1 by the image coding apparatus 200 is transmitted to the image decoding apparatus 220 via the transmission path and supplied to the entropy decoding unit 221. The entropy decoding unit 221 sequentially performs decoding iEC-1 of the entropy coding on the supplied coded data, which has been coded in the entropy coding EC-1, and restores the coefficient data (FIG. 25F). The restored coefficient data is sequentially stored on the coefficient buffer unit 222. If sufficient coefficient data for performing the wavelet inverse transform is stored on the coefficient buffer unit 222, the wavelet inverse transform unit 223 reads the coefficient data from the coefficient buffer unit 222 and performs wavelet inverse transform iWT-1 by using the read coefficient data (FIG. 25G).

As described above with reference to FIG. 20, the wavelet inverse transform iWT-1 by the wavelet inverse transform unit 223 can be started at a timing, at which the coefficient C4 and the coefficient C5 are stored on the coefficient buffer unit 222. Therefore, delay until the wavelet inverse transform iWT-1 by the wavelet inverse transform unit 223 is started after the start of the decoding iEC-1 by the entropy decoding unit 221 corresponds to two lines.

If the wavelet inverse transform iWT-1 of three lines obtained by the first wavelet transform is completed, the wavelet inverse transform unit 223 outputs Out-1 of the image data generated by the wavelet inverse transform iWT-1 (FIG. 25H). In the output Out-1, the image data of the first line is output as described above with reference to FIGS. 20 and 21.

The inputs of the coded coefficient data corresponding to three lines by the first processing of the image coding apparatus 200 to the image decoding apparatus 220 are followed by sequential inputs of coefficient data coded by entropy coding EC-n (n is equal to or greater than two). The image decoding apparatus 220 performs entropy decoding iEC-n and wavelet inverse transform iWT-n on the input coefficient data for every four lines as described above, and outputs Out-n of the image data restored by the wavelet inverse transform iWT-n are sequentially performed. Entropy decoding iEC and wavelet inverse transform iWT corresponding to the final processing of the image coding apparatus 200 are performed on six lines, and the outputs Out of eight lines are made. The processing is performed in parallel by the image decoding apparatus 220 as shown as an example in FIGS. 25F to 25H.

It is possible to perform the image coding processing and the image decoding processing with low delay by performing the respective processing of the image coding apparatus 200 and the image decoding apparatus 220 in parallel in an order from the upper part to the lower part of the screen as described above.

Referring to FIGS. 25A to 25H, delay time until an output of an image after an input of the image when wavelet transform is performed up to the decomposition level=2 by using the 5×3 filter will be calculated. Delay time until image data of the first line is output from the image decoding apparatus 220 after the image data of the first line is input to the image coding apparatus 200 is a sum of the following respective elements. Here, delay that may be different depending on a configuration of the system, such as delay in the transmission path or delay accompanying with an actual processing timing of the respective parts of the apparatus is excluded.

(1) Delay D_WT until the wavelet transform WT-1 of the seven lines is completed after the first line input

(2) Time D_Ord necessary for the coefficient rearrangement Ord-1 of three lines

(3) Time D_EC necessary for the entropy coding EC-1 of three lines

(4) Time D_iEC necessary for the entropy decoding iEC-1 of three lines

(5) Time D_iWT necessary for the wavelet inverse transform iWT-1 of three lines

Referring to FIGS. 25A to 25H, delay calculation by the aforementioned respective elements will be attempted. (1) Delay D_WT is time corresponding to ten lines. (2) Time D_Ord, (3) time D_EC, (4) time D_iEC, and (5) time D_iWT are respective time corresponding to three lines. In addition, the image coding apparatus 200 can start the entropy coding EC-1 one line after the start of the rearrangement Ord-1. Similarly, the image decoding apparatus 220 can start the wavelet inverse transform iWT-1 two lines after the start of the entropy decoding iEC-1. In addition, the processing of the entropy decoding iEC-1 can be started at a timing, at which the coding of one line is completed in the entropy coding EC-1.

Accordingly, delay time until the image decoding apparatus 220 outputs the image data of the first line after the image coding apparatus 200 inputs the image data of the first line corresponds to 10*1+1+2+3=17 lines in the example shown in FIGS. 25A to 25H.

Delay time will be discussed based on a more specific example. When input image data is an interlace video signal of a High Definition Television (HDTV), one frame is configured with resolution of 1920 pixels×1080 lines, and one field corresponds to 1920 pixels×540 lines. Therefore, the 540 lines of one field is input to the image coding apparatus 200 for 16.67 msec (=1 sec/60 fields) when a frame frequency is 30 Hz.

Therefore, delay time accompanying with inputs of the image data corresponding to seven lines is 0.216 msec (=16.67 msec×7/540 lines), which is significantly short time with respect to update time of one field, for example. In addition, delay time as the sum of the aforementioned (1) delay D_WT, (2) time D_Ord, (3) time D_EC, (4) time D_iEC, and (5) time D_iWT is significantly reduced since the number of lines as processing targets is small. It is also possible to further reduce the processing time by configuring the elements performing the respective processing as hardware.

In addition, the rearrangement of the coefficient data may be performed after the entropy coding. In doing so, it is possible to suppress storage capacity necessary for the buffer unit 212 for coefficient rearrangement.

In addition, coded data may be packetized in data transmission between the image coding apparatus 200 and the image decoding apparatus 220.

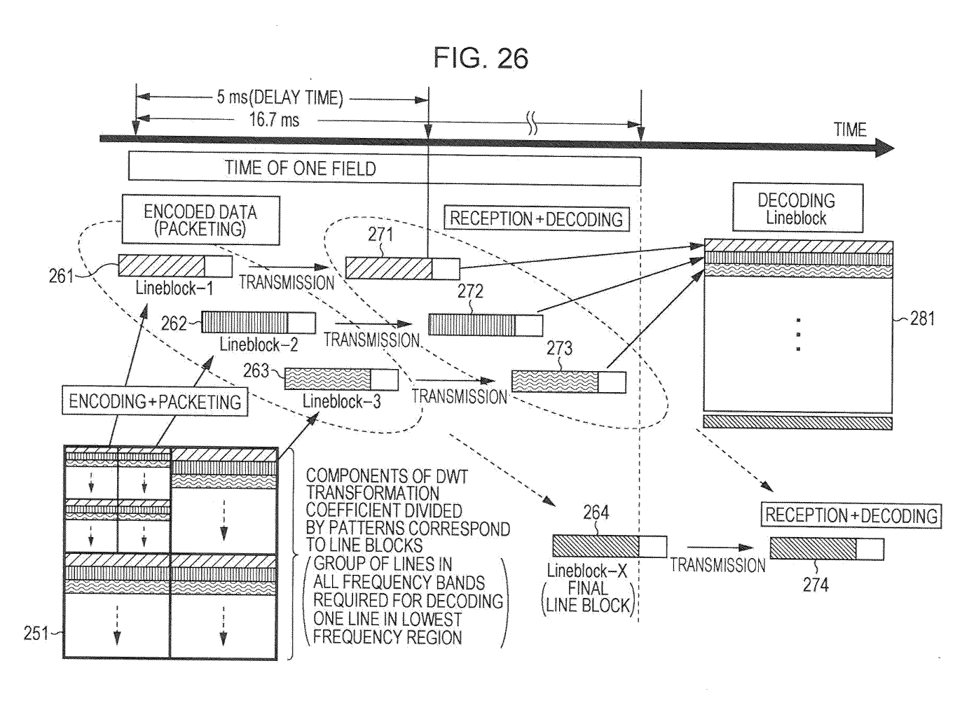

FIG. 26 is a pattern diagram illustrating an example of a state where the coded data is exchanged. As described above, the wavelet transform is performed on the image data while each line block corresponding to a predetermined number of lines is input (sub-band 251). Then, the coefficient lines from the lowest-frequency sub-band to the highest-frequency sub-band are rearranged in an order opposite to the generation order, namely in an order from the low-frequency components to the high-frequency components when the decomposition level of the wavelet transform reaches a predetermined decomposition level.

The parts with different patterns, namely hatched parts, parts with vertical lines, and parts with wave lines are mutually different line blocks in the sub-band 251 shown in FIG. 26 (white parts in the sub-band 251 are also divided into line blocks and processed in the same manner as shown by the arrows). The entropy coding is performed on the coefficients of the line blocks after the rearrangement as described above, and coded data is generated.

Here, when the coded data is transmitted as it is, for example, it is difficult for a device on the side of obtaining the coded data to specify the boundary of each line block (or it is necessary to perform complicated processing) in some cases. Thus, a device on the transmission side adds a header to the coded data in units of line blocks, for example and transmits the coded data as a packet which is configured of the header and the coded data.

That is, the device on the transmission side packetizes the coded data (encoded data) of the first line block (Lineblock-1) and transmits the coded data as a transmission packet 261 as shown in FIG. 26. The device on the receiving side receives the packet (reception packet 271), extracts the coded data, and supplies the coded data to the image decoding apparatus 220. The image decoding apparatus 220 decodes the supplied coded data (the coded data included in the reception packet 271).

Then, the device on the transmission side packetizes the coded data of the second line block (Lineblock-2) and transmits the coded data as a transmission packet 262. The device on the receiving side receives the packet (reception packet 272), extracts the coded data, and supplies the coded data to the image decoding apparatus 220. The image decoding apparatus 220 decodes the supplied coded data (the coded data included in the reception packet 272).

Furthermore, the device on the transmission side generates coded data of the third line block (Lineblock-3), packetizes the coded data, and transmits the coded data as a transmission packet 263. The device on the receiving side receives the packet (reception packet 273), extracts the coded data, and supplies the coded data to the image decoding apparatus 220. The image decoding apparatus 220 decodes the supplied coded data (the coded data included in the reception packet 273).

The device on the transmission side and the device on the receiving side repeat the aforementioned processing up to the X-th final line block (Lineblock-X) (transmission packet 264, reception packet 274). In doing so, a decoded image 281 is generated by the image decoding apparatus 220.

As described above, it is possible to implement coding and decoding with low delay.

### Flow of Recoding Processing

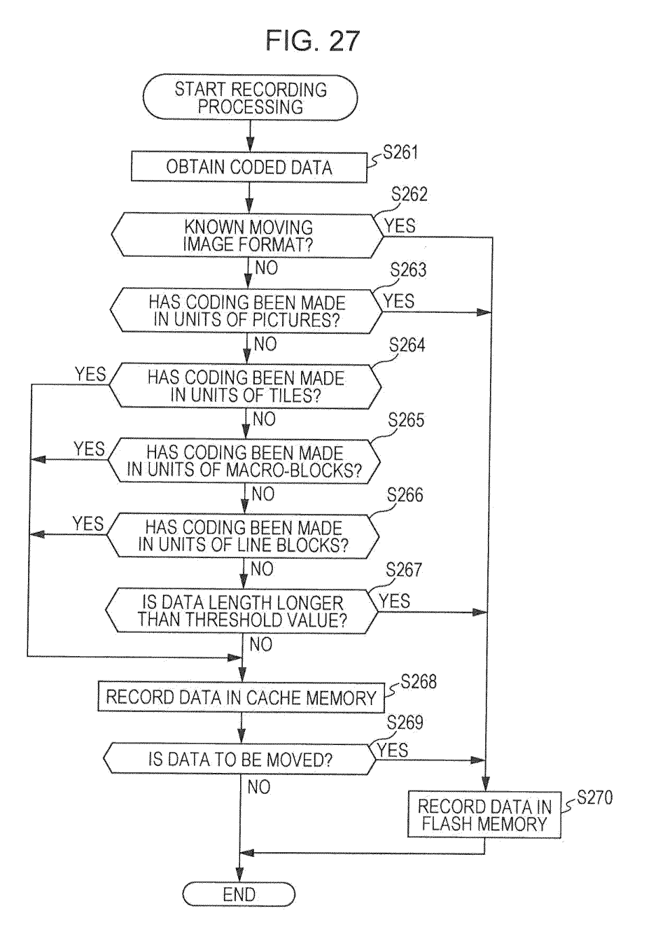

A description will be given of an example of a flow of recording processing when such coded data coded in units of line blocks is also regarded as a processing target, with reference to the flowchart in FIG. 27.

As shown in FIG. 27, the respective processing from Step S261 to Step S265 and from Step S267 to Step S270 in this case are executed basically in the same manner as the respective processing from Step S101 to Step S109 in the example shown in FIG. 11.

However, if it is determined in Step S265 that the coded data is not obtained by coding image data in units of macro-blocks, the processing proceeds to Step S266.

In Step S266, the encoding unit detecting unit 142 determines whether or not the coded data has been created in units of line blocks, based on the information (the parameter set or the header information, for example) included in the coded data. If it is determined that the coded data has not been created by coding the image data in units of line blocks, the processing proceeds to Step S267.

Since the coded data has not been created by coding the image data in known coding units in this case, the detecting unit 131 then examines the data length of the coded data.

If it is determined in Step S266 that the coded data has been created by coding the image data in units of line blocks, the processing proceeds to Step S268. Since the image data has been created by coding the image data in units of line blocks in this case, the data length of the coded data is determined to be sufficiently short. For this reason, the memory selecting unit 132 records the coded data as a processing target in the non-volatile cache memory 123 in Step S268.

Even in this case, the memory storage 111 (SSD) can appropriately control availability of the cache memory in accordance with the data length and efficiently record the data regardless of whether or not the data is big data. In doing so, the memory storage 111 can suppress an increase in power consumption, a decrease in the data writing speed, and a decrease in a period, during which data can be written in the recording medium.

When the coded data has been created by coding image data in units of line blocks as in the example described above with reference to the flowchart in FIG. 13, the data length of the coded data may be compared with a threshold value for the line block unit.

### 3. Third Embodiment

### Memory Storage

When the client 103 downloads data from the cloud server 101, for example, the cloud server 101 reads the requested data from the memory storage 111 which stores the data, and transmits the data to the client 103.

A large number of various kinds of video content, image videos of music companies, promotion videos of singers, and the like have been uploaded to the cloud server 101. Such content can be accessed from a terminal (the client 103) which is individually used, such as a PC, a tablet, or a smart phone, and desired content can be downloaded and viewed by a display terminal.

For such data reading, the controller 121 of the memory storage 111 reads the requested data from the NAND flash memory 122 and outputs the data to the outside of the memory storage 111.

At that time, if image data is fractionally recorded in the NAND flash memory 122, such data may be stored once on the non-volatile cache memory 123 and then read and downloaded. In contrast, for a file in a moving image format or a case where the size of image data is large, it is effective to read and download the data stored on the NAND flash memory 122.

However, there is a possibility that a degree of overcrowding of the network further increases and there is a higher possibility that high delay occurs in the transmission time if a large amount of data is transmitted and received at the same time when a line of the network 102 as a transmission medium is overcrowded and data congestion occurs. Thus, a line state of the network 102 may be constantly grasped and data may be downloaded within a range of an allowable transmission rate, at which transmission can be performed, in accordance with an effective speed at that time when image data is downloaded from the cloud server 101.

### Data Reading

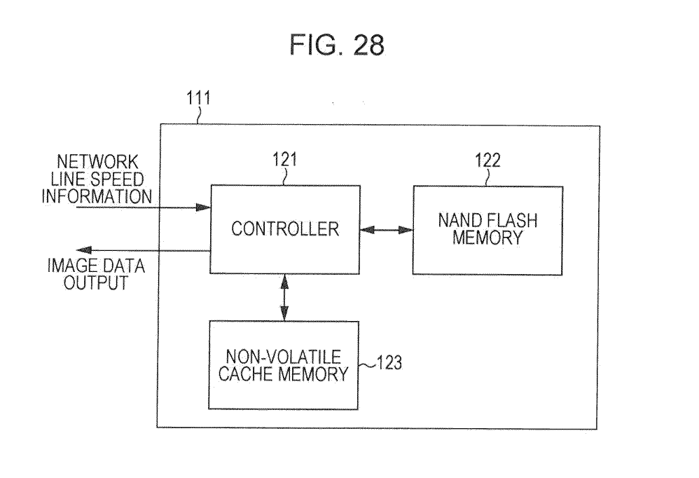

A description will be given of a state of the memory storage 111 when such data is read, with reference to FIG. 28.

In this case, the controller 121 selects whether to download the coded data from the large-capacity NAND flash memory 122 at the same time or to download the image data little by little from the non-volatile cache memory 123 within a range of the line speed while the coded image data is partially moved from the NAND flash memory 122 to the non-volatile cache memory 123, in accordance with information (the line speed of the network) from the outside, for example.

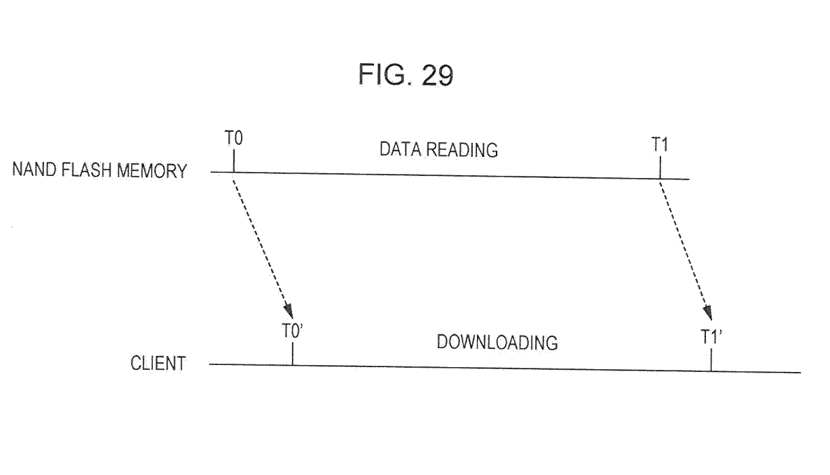

When the line speed is high as shown in FIG. 29, for example, the controller 121 reads the coded data from the NAND flash memory 122 and outputs the coded data without storing the coded data on the non-volatile cache memory 123. Therefore, the read coded data is sequentially downloaded to the client 103 via the network 102.

That is, reading of the coded data is started at time T0, and the reading is completed at time T1 in the NAND flash memory 122. On the other hand, obtaining of the coded data is started at time T0′ and the obtaining is completed at time T1′ in the client 103.

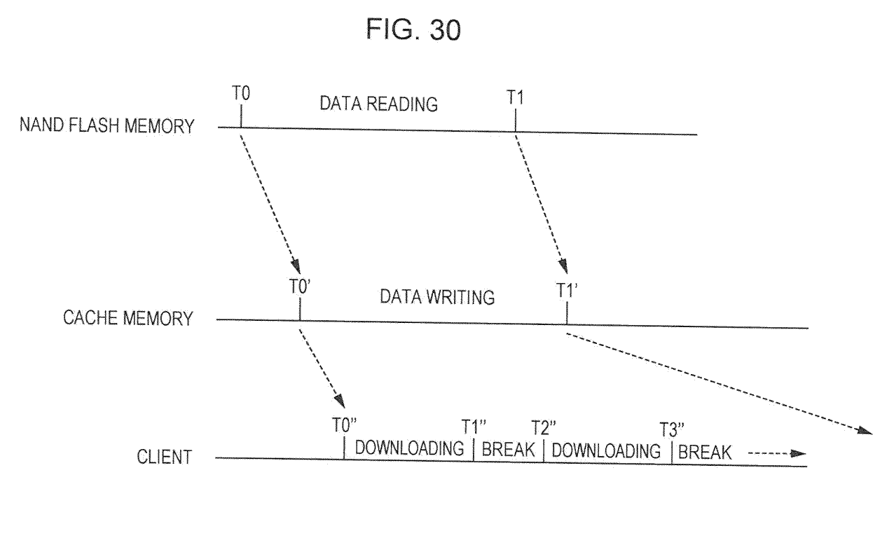

When the line speed is low as shown in FIG. 30, for example, the controller 121 reads the coded data from the NAND flash memory 122, stores the coded data once on the non-volatile cache memory 123, and outputs the coded data therefrom.

Therefore, reading of the coded data is started at the time T0, and the reading is completed at the time T1 in the NAND flash memory 122. Writing of the coded data is started at the time T0′, and the writing is completed at the time T1′ in the non-volatile cache memory 123. Obtaining of the first coded data is started at time T0″, and the obtaining of the first coded data is completed at time T1″ in the client 103 in accordance with the line speed.

Thereafter, break time is prepared in accordance with the line speed (the break time extends as the line speed decreases), obtaining of the second coded data is then started at time T2″, and the obtaining of the second coded data is completed at time T3″.

Thereafter, break time is provided again in the same manner. Such operations are repeated until there is no coded data.

If the line speed is low when the coded data read from the NAND flash memory 122 is transmitted to the client 103 without being stored once on the non-volatile cache memory 123, stand-by processing frequently occurs in the processing of reading the image data from the NAND flash memory 122. If reading from the NAND flash memory is stopped once and then performed, it is difficult to take advantage of the property of the NAND flash memory that a large amount of data is read at a high speed, and there is a concern that the reading speed adversely decreases and a lifetime of the memory decreases.

Therefore, the controller 121 reads the data from the non-volatile cache memory 123 at an appropriate timing while moving the data to the non-volatile cache memory 123 which is suitable for reading small-capacity data.

### Flow of Reading Processing

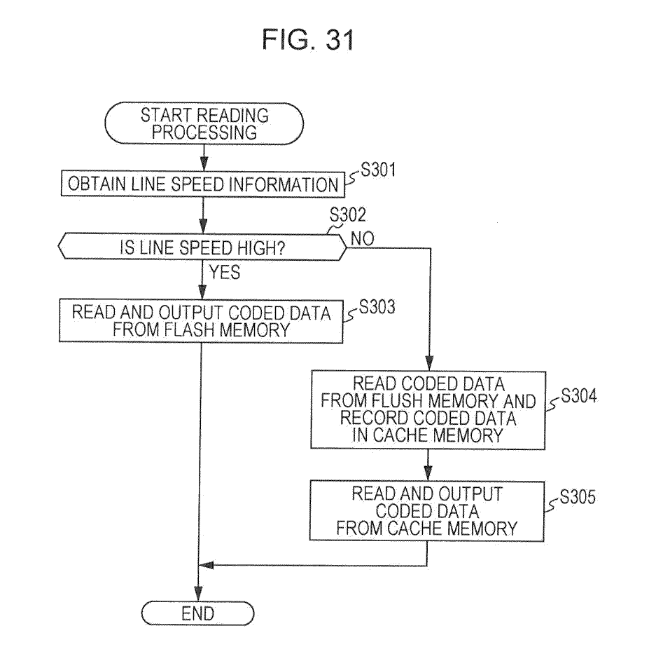

A description will be given of an example of a flow of reading processing executed by the controller 121 shown in FIG. 28 when the coded data recorded in the NAND flash memory 122 is supplied to the client 103, with reference to the flowchart shown in FIG. 31.

When the reading processing is started, the controller 121 obtains line speed information of the network 102 in Step S301.

In Step S302, the controller 121 determines whether or not the line speed of the network 102 is sufficiently high based on the line speed information. If it is determined that the line speed is sufficiently high, the processing proceeds to Step S303.

In Step S303, the controller 121 reads desired coded date from the NAND flash memory 122 and outputs the coded data without storing the coded data once on the non-volatile cache memory 123. If the processing in Step S303 is completed, the reading processing is completed.

If it is determined in Step S302 that the line speed of the network 102 is not sufficiently high, the processing proceeds to Step S304.

In Step S304, the controller 121 reads desired coded data from the NAND flash memory 122, supplies the read coded data to the non-volatile cache memory 123, and causes the non-volatile cache memory 123 to store the coded data (records the coded data in the non-volatile cache memory 123).

In Step S305, the controller 121 reads and outputs the coded data stored on the non-volatile cache memory 123 at a predetermined timing. When the processing in Step S305 is completed, the reading processing is completed.

The memory storage 111 (SSD) can appropriately control availability of the cache memory in accordance with the line speed and it is possible to more efficiently read the data regardless of whether or not the data is big data, by the controller 121 executing the reading processing as described above. In doing so, the memory storage 111 can suppress an increase in power consumption and a decrease in the data reading speed.

As described above, the information processing system 100 has an effect that it is possible to constantly execute high-performance uploading by using the non-volatile cache memory and the large-capacity flash memory depending on the conditions such as the data length and the image format when large-capacity data called big data is uploaded from a client to a cloud server. In addition, since downloading from the cache is selected for fragmentary small data and direct downloading from the flash memory is selected for large-capacity data, it is possible to achieve an effect that usage frequency of the flash memory is reduced, that power consumption of the flash memory and the storage apparatus is reduced as a whole, and that the lifetime extends.

That is, it is possible to suppress an increase in power consumption, a decrease in the data reading speed, a decrease in the writing speed, and a decrease in a period, during which data can be written in the recording medium, by efficiently recording and reproducing data.

In addition, the present disclosure can be applied to a data communication system or the like between an arbitrary client and a server. Particularly, the server can be accumulation of massive data, services, information on software and the like on the Internet, which is called a cloud. In addition, the client can be a smart phone, a personal computer, a tablet, a security camera, or a camera for medical use, for example. The present disclosure can be applied to any system as long as the system is configured such that some data (sound, images, texts, and the like) is transmitted from an information device on the client side to the cloud via the Internet.

For example, the present disclosure can be applied to a system which uploads video image data to a cloud, a system which implements medical data services between hospitals, a system which implements a nationwide library browsing service, software modules or services thereof, and the like.

### 4. Fourth Embodiment

### Computer

The aforementioned series of processing can be executed by hardware or software. When the series of processing is executed by software, a program configuring the software is installed in a computer. Here, the computer includes a computer embedded in dedicated hardware and a general-purpose personal computer, for example, capable of executing various functions by installing various programs.

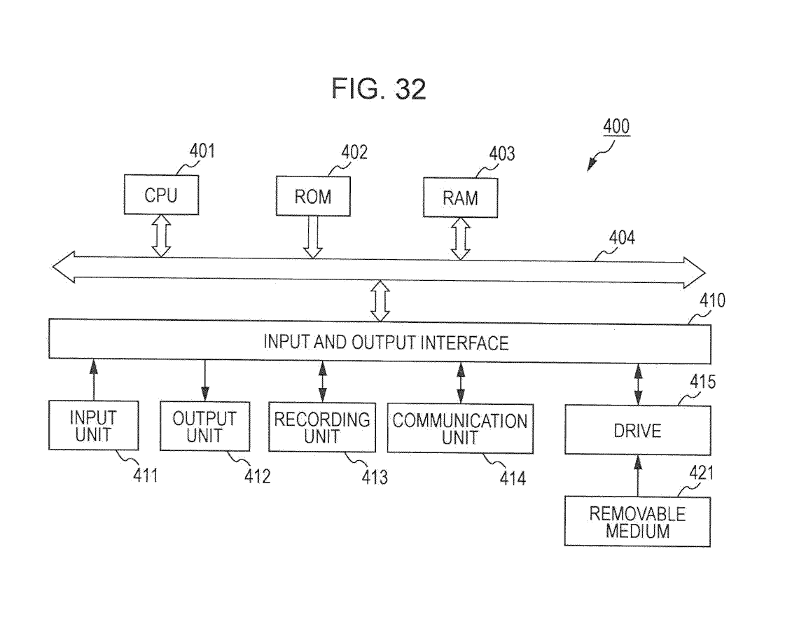

FIG. 32 is a block diagram showing a configuration example of hardware of a computer which executes the aforementioned series of processing based on a program.

In a computer 400 shown in FIG. 32, a Central Processing Unit (CPU) 401, a Read Only Memory (RAM) 402, a Random Access Memory (RAM) 403 are connected to each other via a bus 404.

An input and output interface 410 is also connected to the bus 404. An input unit 411, an output unit 412, a storage unit 413, a communication unit 414, and a drive 415 are connected to the input and output interface 410.

The input unit 411 is configured of a keyboard, a mouse, a microphone, a touch panel, and an input terminal, for example. The output unit 412 is configured of a display, a speaker, and an output terminal, for example. The storage unit 413 is configured of a hard disk, a RAM disk, and a non-volatile memory, for example. The communication unit 414 is configured of a network interface, for example. The drive 415 drives a removable medium 421 such as a magnetic disk, an optical disc, a magnetooptical disc, or a semiconductor memory.

The computer configured as described above performs the aforementioned series of processing by causing the CPU 401 to load a program stored on the storage unit 413 to the RAM 403 via the input and output interface 410 and the bus 404 and execute the program, for example. The RAM 403 also appropriately stores data necessary to cause the CPU 401 to execute various kinds of processing.

The program executed by the computer (CPU 401) can be applied by being recorded in the removable medium 421 as a package medium, for example. In addition, the program can be provided via a wired or wireless transmission medium such as a local area network, the Internet, or digital satellite broadcasting.

The computer can install the program to the storage unit 413 via the input and output interface 410 by mounting the removable medium 421 on the drive 415. In addition, the program can be received by the communication unit 414 via a wired or wireless transmission medium and installed to the storage unit 413. In addition, the program can be installed in advance to the ROM 402 or the storage unit 413.

Moreover, the program executed by the computer may be a program for performing the processing in a time-series manner in an order of the description in this specification or may be a program for performing processing in parallel or at a necessary timing such as a timing when the program is accessed.

In this specification, although a step of describing a program to be recorded in a recording medium includes processing performed in a time-series manner in the description order, of course, the processing is not necessarily performed in the time-series manner, and the step further includes processing performed in parallel or in an individual manner.

In this specification, the system means a group of a plurality of constituents (apparatuses, modules (components), and the like) regardless of whether or not all the constituents are in the same case body. Therefore, both a plurality of apparatuses contained in different case bodies and connected via a network and one apparatus accommodating a plurality of modules in one case body are systems.

A configuration described above as one apparatus (or a processing unit) may be divided and configured as a plurality of apparatuses (or processing units). In contrast, configurations described above as a plurality of apparatuses (or processing units) may be collectively configured as one apparatus (or a processing unit). In addition, configurations other than the aforementioned configuration may be added to the configurations of the respective apparatuses (or the respective processing units). Furthermore, a part of a specific apparatus (or a processing unit) may be included in a configuration of another apparatus (or another processing unit) as long as substantially the same configurations and operations of the system can be achieved as a whole.

Although the detailed description was given of preferred embodiments of the present disclosure with reference to the accompanying drawings, a technical scope of the present disclosure is not limited to such examples. It is obvious that those skilled in the art can achieve various modification examples or amended examples within a range of technical ideas described in the claims, and it should be understood that such modification examples and amended examples also belong to the technical scope of the present disclosure.

For example, the present disclosure can have a configuration of cloud computing, in which one function is shared and cooperatively processed by a plurality of apparatuses via a network.

In addition, the respective steps described with reference to the aforementioned flowcharts can be executed by one apparatus or can be shared and executed by a plurality of apparatuses.

Furthermore, when a plurality of processing is included in one step, the plurality of processing included in one step can be executed by one apparatus or can be shared and executed by a plurality of apparatuses.

In addition, the present disclosure can employ the following configurations.

(1) An information processing apparatus including: a first storage unit which stores coded data obtained by coding image data; a second storage unit, which stores the coded data, storage capacity of which is smaller compared to that of the first storage unit, a data reading speed and a data writing speed of which are higher compared to those of the first storage unit; and a control unit which receives the coded data, and supplies the coded data to the first storage unit and causes the first storage unit to store the coded data when a data length of the received coded data is longer compared to a predetermined threshold value, or supplies the coded data to the second storage unit, causes the second storage unit to store the coded data, reads the coded data in units of data length which is longer compared to the threshold value from the second storage unit, supplies the coded data to the first storage unit, and causes the first storage unit to store the coded data when the data length of the received coded data is shorter compared to the predetermined threshold value.

(2) The apparatus according to any one of (1) and (3) to (18), in which the control unit supplies the coded data to the first storage unit and causes the first storage unit to store the coded data when a format of the received coded data is a known moving image data format.

(3) The apparatus according to any one of (1), (2), and (4) to (18), in which the control unit supplies the coded data to the first storage unit and causes the first storage unit to store the coded data when the received coded data is obtained by coding the image data in units of pictures.

(4) The apparatus according to any one of (1) to (3) and (5) to (18), in which the control unit supplies the coded data to the second storage unit and causes the second storage unit to store the coded data when the received coded data is obtained by coding the image data in units of tiles.

(5) The apparatus according to any one of (1) to (4) and (6) to (18), in which the control unit supplies the coded data to the second storage unit and causes the second storage unit to store the coded data when the received coded data is obtained by coding the image data in units of tiles and the data length is shorter compared to a threshold value for the tiles.

(6) The apparatus according to any one of (1) to (5) and (7) to (18), in which the control unit supplies the coded data to the second storage unit and causes the second storage unit to store the coded data when the received coded data is obtained by coding the image data in units of macro-blocks.

(7) The apparatus according to any one of (1) to (6) and (8) to (18), in which the control unit supplies the coded data to the second storage unit and causes the second storage unit to store the coded data when the received coded data is obtained by coding the image data in units of macro-blocks and the data length is shorter compared to a threshold value for the macro-blocks.

(8) The apparatus according to any one of (1) to (7) and (9) to (18), in which the control unit supplies the coded data to the second storage unit and causes the second storage unit to store the coded data when the received coded data is obtained by coding the image data in units of line blocks.

(9) The apparatus according to any one of (1) to (8) and (10) to (18), in which the control unit supplies the coded data to the second storage unit and causes the second storage unit to store the coded data when the received coded data is obtained by coding the image data in units of line blocks and the data length is shorter compared to a threshold value for the line blocks.

(10) The apparatus according to any one of (1) to (9) and (11) to (18), in which the coded data is obtained by performing wavelet transform on the image data and coding the obtained wavelet transform coefficients, and in which each of the line blocks is a block of the image data including a necessary number of lines for generating at least one line of lowest components in the wavelet transform.

(11) The apparatus according to any one of (1) to (10) and (12) to (18), in which the first storage unit includes a non-volatile memory.

(12) The apparatus according to any one of (1) to (11) and (1.3) to (18), in which the non-volatile memory is a NAND flash memory.

(13) The apparatus according to any one of (1) to (12) and (14) to (18), in which the second storage unit includes a non-volatile memory.

(14) The apparatus according to any one of (1) to (13) and (15) to (18), in which the non-volatile memory is a magnetic memory.

(15) The apparatus according to any one of (1) to (14) and (16) to (18), in which the magnetic memory is an MRAM.

(16) The apparatus according to any one of (1) to (15), (17), and (18), in which the non-volatile memory is a resistance variation-type memory.

(17) The apparatus according to any one of (1) to (16) and (18), in which the resistance variation-type memory is an ReRAM.

(18) The apparatus according to any one of (1) to (17), in which when the coded data stored on the first storage unit is read and output, the control unit outputs the coded data read from the first storage unit when a line speed is high, or supplies the coded data read from the first storage unit to the second storage unit, causes the second storage unit to store the coded data, and reads and outputs the coded data from the second storage unit at a predetermined timing when the line speed is low.

(19) An information processing method including: receiving coded data obtained by coding image data; and supplying the coded data to a first storage unit and causing the first storage unit to store the coded data when a data length of the received coded data is longer compared to a predetermined threshold value; or supplying the coded data to a second storage unit, causing the second storage unit to store the coded data, reading the coded data in units of data length which is longer compared to the threshold value from the second storage unit, supplying the coded data to the first storage unit, and causing the first storage unit to store the coded data when the data length of the received coded data is shorter compared to the predetermined threshold value, storage capacity of the second storage unit being smaller compared to that of the first storage unit, a data reading speed and a data writing speed of the second storage unit being higher compared to those of the first storage unit.

(20) A program which causes a computer to execute processing of: receiving coded data obtained by coding image data; and supplying the coded data to a first storage unit and causing the first storage unit to store the coded data when a data length of the received coded data is longer compared to a predetermined threshold value; or supplying the coded data to a second storage unit, causing the second storage unit to store the coded data, reading the coded data in units of data length which is longer compared to the threshold value from the second storage unit, supplying the coded data to the first storage unit, and causing the first storage unit to store the coded data when the data length of the received coded data is shorter compared to the predetermined threshold value, storage capacity of the second storage unit being smaller compared to that of the first storage unit, a data reading speed and a data writing speed of the second storage unit being higher compared to those of the first storage unit.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a first storage unit which stores coded data obtained by coding image data;
a second storage unit, which stores the coded data, storage capacity of which is smaller compared to that of the first storage unit, and a data reading speed and a data writing speed of which are higher compared to those of the first storage unit; and
a control unit which receives the coded data, and supplies the coded data to the first storage unit and causes the first storage unit to store the coded data when a data length of the received coded data is longer compared to a predetermined threshold value, or supplies the coded data to the second storage unit, causes the second storage unit to store the coded data, reads the coded data in units of data length which is longer compared to the threshold value from the second storage unit, supplies the coded data to the first storage unit, and causes the first storage unit to store the coded data when the data length of the received coded data is shorter compared to the predetermined threshold value.

2. The information processing apparatus according to claim 1,
wherein the control unit supplies the coded data to the first storage unit and causes the first storage unit to store the coded data when a format of the received coded data is a known moving image data format.

3. The information processing apparatus according to claim 1,
wherein the control unit supplies the coded data to the first storage unit and causes the first storage unit to store the coded data when the received coded data is obtained by coding the image data in units of pictures.

4. The information processing apparatus according to claim 1,
wherein the control unit supplies the coded data to the second storage unit and causes the second storage unit to store the coded data when the received coded data is obtained by coding the image data in units of tiles.

5. The information processing apparatus according to claim 4,
wherein the control unit supplies the coded data to the second storage unit and causes the second storage unit to store the coded data when the received coded data is obtained by coding the image data in units of tiles and the data length is shorter compared to a threshold value for the tiles.

6. The information processing apparatus according to claim 1,
wherein the control unit supplies the coded data to the second storage unit and causes the second storage unit to store the coded data when the received coded data is obtained by coding the image data in units of macro-blocks.

7. The information processing apparatus according to claim 6,
wherein the control unit supplies the coded data to the second storage unit and causes the second storage unit to store the coded data when the received coded data is obtained by coding the image data in units of macro-blocks and the data length is shorter compared to a threshold value for the macro-blocks.

8. The information processing apparatus according to claim 1,
wherein the control unit supplies the coded data to the second storage unit and causes the second storage unit to store the coded data when the received coded data is obtained by coding the image data in units of line blocks.

9. The information processing apparatus according to claim 8,
wherein the control unit supplies the coded data to the second storage unit and causes the second storage unit to store the coded data when the received coded data is obtained by coding the image data in units of line blocks and the data length is shorter compared to a threshold value for the line blocks.

10. The information processing apparatus according to claim 8,
wherein the coded data is obtained by performing wavelet transform on the image data and coding the obtained wavelet transform coefficients, and
wherein each of the line blocks is a block of the image data including a necessary number of lines for generating at least one line of lowest components in the wavelet transform.

11. The information processing apparatus according to claim 1,
wherein the first storage unit includes a non-volatile memory.

12. The information processing apparatus according to claim 11,
wherein the non-volatile memory is a NAND flash memory.

13. The information processing apparatus according to claim 1,
wherein the second storage unit includes a non-volatile memory.

14. The information processing apparatus according to claim 13,
wherein the non-volatile memory is a magnetic memory.

15. The information processing apparatus according to claim 14,
wherein the magnetic memory is an MRAM.

16. The information processing apparatus according to claim 13,
wherein the non-volatile memory is a resistance variation-type memory.

17. The information processing apparatus according to claim 16,
wherein the resistance variation-type memory is an ReRAM.

18. The information processing apparatus according to claim 1,
wherein when the coded data stored on the first storage unit is read and output, the control unit outputs the coded data read from the first storage unit when a line speed is high, or supplies the coded data read from the first storage unit to the second storage unit, causes the second storage unit to store the coded data, and reads and outputs the coded data from the second storage unit at a predetermined timing when the line speed is low.

19. An information processing method comprising:
receiving coded data obtained by coding image data; and
supplying the coded data to a first storage unit and causing the first storage unit to store the coded data when a data length of the received coded data is longer compared to a predetermined threshold value; or
supplying the coded data to a second storage unit, causing the second storage unit to store the coded data, reading the coded data in units of data length which is longer compared to the threshold value from the second storage unit, supplying the coded data to the first storage unit, and causing the first storage unit to store the coded data when the data length of the received coded data is shorter compared to the predetermined threshold value, storage capacity of the second storage unit being smaller compared to that of the first storage unit, a data reading speed and a data writing speed of the second storage unit being higher compared to those of the first storage unit.

20. A program which causes a computer to execute processing of:
receiving coded data obtained by coding image data; and
supplying the coded data to a first storage unit and causing the first storage unit to store the coded data when a data length of the received coded data is longer compared to a predetermined threshold value; or
supplying the coded data to a second storage unit, causing the second storage unit to store the coded data, reading the coded data in units of data length which is longer compared to the threshold value from the second storage unit, supplying the coded data to the first storage unit, and causing the first storage unit to store the coded data when the data length of the received coded data is shorter compared to the predetermined threshold value, storage capacity of the second storage unit being smaller compared to that of the first storage unit, a data reading speed and a data writing speed of the second storage unit being higher compared to those of the first storage unit.
